(19) United States
(12) Patent Application Publication
(10) Pub. No.: US 2026/0071107 A1
(43) Pub. Date: Mar. 12, 2026

(54) HEAT TRANSFER COMPOSITIONS AND METHODS OF RETROFITTING HEAT TRANSFER SYSTEMS

(71) Applicant: HONEYWELL INTERNATIONAL INC., Charlotte, NC (US)

(72) Inventors: Martin Bluhm, Buffalo, NY (US); Ankit Sethi, Buffalo, NY (US); David Smith, Buffalo, NY (US); Nilesh Purohit, Buffalo, NY (US)

(73) Assignee: HONEYWELL INTERNATIONAL INC., Charlotte, NC (US)

(21) Appl. No.: 19/311,561

(22) Filed: Aug. 27, 2025

Related U.S. Application Data
(60) Provisional application No. 63/692,023, filed on Sep. 6, 2024.

(51) Int. Cl. C09K 5/04; B60H 1/00

(52) U.S. Cl. CPC C09K 5/045; B60H 1/00585; C09K 2205/11; C09K 2205/126

(57) ABSTRACT

The present invention relates to heat transfer compositions comprising 1234yf refrigerant, PAG lubricant and dispersant and to methods of retrofitting R134a MAC systems with using such compositions.

### CROSS REFERENCE TO RELATED APPLICATIONS

The present invention relates to and claims the priority benefit of U.S. Provisional Application 63/692,023, filed Sep. 6, 2024, the entire contents of which are incorporated herein by reference.

### FIELD OF THE INVENTION

The present invention relates to compositions, methods and systems having utility in heat exchange applications, including in mobile air conditioning (MAC) applications. In particular aspects the invention relates to compositions useful in retrofitting existing heat transfer systems, including MAC systems, in which R134a is the existing refrigerant.

### BACKGROUND

Mechanical refrigeration systems, and related heat transfer devices, such as heat pumps and air conditioners, are well known in the art for industrial, commercial and domestic uses. Chlorofluorocarbons (CFCs), such as R22 were developed in the 1930s as refrigerants for such systems. However, since the 1980s, the effect of CFCs on the stratospheric ozone layer has been a major detriment to the use of such materials. In 1987, a number of governments signed the Montreal Protocol to protect the global environment, setting forth a timetable for phasing out the CFC products. At least partially in response to the need for a non-flammable, non-toxic alternative to the CFCs in MAC applications, the industry developed R-134a, which has a zero ozone depletion potential.

While R-134a has a more acceptable Ozone Depleting Potential (ODP) than CFCs, the continued use of R-134a has become problematic since it has a high Global Warming Potential (GWP) of 2088. There has therefore been a need in the art for the replacement of R-134a with a more environmentally acceptable alternative.

The new refrigerant HFO-1234yf developed by Honeywell International, Inc., the assignee of the present application, has long been the most preferred and commercially successful low GWP refrigerant for use in MAC applications instead of R-134a. Moreover, one of the many advantages of HFO-1234yf is that it has exceptionally high levels of miscibility with many older PAG lubricants, including those which had previously been used with R134a. In addition, some newer PAG lubricants have been specifically formulated to have high miscibility when used with HFO-1234yf. See, for example, U.S. Pat. Nos. 9,587,202 and 11,427,777, each of which is incorporated herein by reference. In general, a high level of miscibility between a refrigerant and the lubricant with which it is used is important for maintenance of system efficiency and proper and reliable functioning of the compressor. In particular, it is generally preferred, especially in MAC systems, that the combination of lubricant and 1234yf has sufficient miscibility to ensure that the lubricant circulates in the vapor compression cycle and is returned to the compressor to perform its intended lubricating function without accumulating in and become lodged in the coils and/or piping of the system. Furthermore, when lubricant accumulates on the surfaces of heat transfer components, such as the evaporator, it lowers the heat exchange efficiency, and thereby reduces the efficiency of the system.

However, applicants have come to appreciate that a few PAG lubricants have a baseline miscibility that is not as exceptionally high as many of the other PAG lubricants that had been used in systems with R134a, and that systems with base-line PAG lubricants continue to exist and operate on a daily basis. Thus, applicants have come to recognize a continuing need and desire for low cost methods to help protect the environment by removing R-134a from existing systems that use base-line miscibility PAG lubricants and replacing the R134a with refrigerant that contains HFO-1234yf. Although it is possible that such systems can be achieved by removing the older, base-line miscibility PAG lubricant from the system, via flushing or other methods, this solution is undesirable at least from the standpoint of the time and cost of removing existing lubricant from such systems.

Applicants have come to appreciate that in such cases these difficulties, and potentially other difficulties, can be avoided, and important advantages can be achieved, by using the present heat transfer compositions, the present retrofit methods and the present supplemental lubricant packages.

### SUMMARY

The present invention includes liquid heat transfer compositions comprising refrigerant, lubricant and dispersant, wherein:
(a) said refrigerant comprises at least about 50% by weight of HFO-1234yf;
(b) said lubricant consists essentially of PAG lubricant in an amount of from about 0.01% by weight to about 10% by weight based on the weight of said refrigerant and said lubricant; and
(c) said dispersant is present in an amount of from about 1% by weight to about 5% by weight based on the weight of said PAG lubricant and said dispersant; and
(d) said heat transfer composition is a single phase fluid over the temperature range of from about −10° C. to about 55° C.

The heat transfer composition according to this paragraph is sometimes referred to herein for convenience as Heat Transfer Composition 1.

The present invention includes liquid heat transfer compositions comprising refrigerant, lubricant and dispersant, wherein:
(a) said refrigerant comprises at least about 50% by weight of HFO-1234yf;
(b) said lubricant consists essentially of PAG lubricant in an amount of from about 0.01% by weight to about 10% by weight based on the weight of said refrigerant and said lubricant; and
(c) said dispersant is present in an amount of from about 1% by weight to about 5% by weight based on the weight of said PAG lubricant and said dispersant; and
(d) said heat transfer composition is a single phase fluid over the temperature range of from about −10° C. to about 55° C. and in the absence of said dispersant said heat transfer composition is not a single phase fluid over the temperature range of from about −10° C. to about 55° C.
   The heat transfer composition according to this paragraph is sometimes referred to herein for convenience as Heat Transfer Composition 2A.

The present invention includes liquid heat transfer compositions comprising refrigerant, base-line miscibility PAG lubricant and dispersant, wherein:
(a) said refrigerant comprises at least about 50% by weight of HFO-1234yf;
(b) said base-line miscibility PAG lubricant is present in an amount of from about 0.01% by weight to about 10% by weight based on the weight of said refrigerant and said lubricant; and
(c) said dispersant is present in an amount of from about 1% by weight to about 5% by weight based on the weight of said base-line miscibility PAG lubricant and said dispersant; and
(d) said heat transfer composition is a single phase fluid over the temperature range of from about-10° C. to about 55° C.
   The heat transfer composition according to this paragraph is sometimes referred to herein for convenience as Heat Transfer Composition 2B.

The present invention includes liquid heat transfer compositions comprising refrigerant, lubricant and dispersant, wherein:
(a) said refrigerant comprises at least about 50% by weight of HFO-1234yf;
(b) said lubricant consists essentially of PAG lubricant in an amount of from about 0.01% by weight to about 10% by weight based on the weight of said refrigerant and said lubricant; and
(c) said dispersant comprises one or more succinimide based dispersants, and/or one or more succinimide based dispersants, and/or one or more amine ethoxylates present in an amount of from about 1% by weight to about 5% by weight based on the weight of said PAG lubricant and said dispersant; and
(d) said heat transfer composition is a single phase fluid over the temperature range of from about −10° C. to about 55° C. and in the absence of said dispersant said heat transfer composition is not a single phase fluid over the temperature range of from about −10° C. to about 55° C.
   The heat transfer composition according to this paragraph is sometimes referred to herein for convenience as Heat Transfer Composition 3A.

The present invention includes liquid heat transfer compositions comprising refrigerant, base-line miscibility PAG lubricant and dispersant, wherein:
(a) said refrigerant comprises at least about 50% by weight of HFO-1234yf;
(b) said lubricant consists essentially of base-line miscibility PAG lubricant in an amount of from about 0.01% by weight to about 10% by weight based on the weight of said refrigerant and said lubricant; and
(c) said dispersant comprises one or more succinimide based dispersants, and/or one or more succinimide based dispersants, and/or one or more amine ethoxylates present in an amount of from about 1% by weight to about 5% by weight based on the weight of said base-line miscibility PAG lubricant and said dispersant; and
(d) said heat transfer composition is a single phase fluid over the temperature range of from about −10° C. to about 55° C.
   The heat transfer composition according to this paragraph is sometimes referred to herein for convenience as Heat Transfer Composition 3B.

The present invention includes liquid heat transfer compositions comprising refrigerant, lubricant and dispersant, wherein:
(a) said refrigerant comprises at least about 50% by weight of HFO-1234yf;
(b) said lubricant consists essentially of PAG lubricant in an amount of from about 0.01% by weight to about 10% by weight based on the weight of said refrigerant and said lubricant; and
(c) said dispersant comprises one or more polyalkylsuccinimide-polyamines and/or one or more polyalkylsuccinamide-polyamines, and/or one or more amine ethoxylates present in an amount of from about 1% by weight to about 5% by weight based on the weight of said PAG lubricant and said dispersant; and
(d) said heat transfer composition is a single phase fluid over the temperature range of from about −10° C. to about 55° C. and in the absence of said dispersant said heat transfer composition is not a single phase fluid over the temperature range of from about −10° C. to about 55° C.
   The heat transfer composition according to this paragraph is sometimes referred to herein for convenience as Heat Transfer Composition 3C.

The present invention includes liquid heat transfer compositions comprising refrigerant, base-line miscibility PAG lubricant and dispersant, wherein:
(a) said refrigerant comprises at least about 50% by weight of HFO-1234yf;
(b) said lubricant consists essentially of base-line miscibility PAG lubricant in an amount of from about 0.01% by weight to about 10% by weight based on the weight of said refrigerant and said lubricant; and
(c) said dispersant comprises one or more polyalkylsuccinamide-polyamines and/or one or more amine ethoxylates present in an amount of from about 1% by weight to about 5% by weight based on the weight of said base-line miscibility PAG lubricant and said dispersant; and
(d) said heat transfer composition is a single phase fluid over the temperature range of from about −10° C. to about 55° C.
   The heat transfer composition according to this paragraph is sometimes referred to herein for convenience as Heat Transfer Composition 3D.

The present invention includes methods of retrofitting existing MAC systems that contain R134a and existing PAG lubricant with more environmentally desirable refrigerants comprising HFO-1234yf, said retrofitting methods comprising: (a) ensuring that the existing MAC system is essentially free of the existing R134a refrigerant without taking steps to remove any existing PAG lubricant that remains in the system after said R134a removal; (b) after said ensuring step (a), introducing into the system refrigerant comprising at least about 50% by weight of HFO-1234yf and (c) either before, after, and/or simultaneous with said introducing step (b), introducing into the system a supplemental PAG lubricant composition, wherein the amount of said supplemental PAG lubricant introduced is from about 5% to about 20% of the design lubricant load of the system, wherein the supplemental PAG lubricant composition comprises a dispersing agent which enhances the miscibility of said existing PAG lubricant and said HFO-1234yf. The retrofitting methods of according to this paragraph are sometimes referred to herein for convenience as Retrofitting Method 1.

The present invention also includes methods of retrofitting existing MAC systems that contain R134a and existing PAG lubricant with more environmentally desirable refrigerants comprising HFO-1234yf, said retrofitting methods comprising: (a) ensuring that the existing MAC system is essentially free of the existing R134a refrigerant without taking steps to remove any existing PAG lubricant that remains in the system after said R134a removal; (b) after said ensuring step (a), introducing into the system a supplemental PAG lubricant composition, wherein the amount of said supplemental PAG lubricant introduced is from about 5% to about 20% of the design lubricant load of the system, wherein the supplemental PAG lubricant composition comprises a dispersant to produce a heat transfer composition of the present invention, including each of Heat Transfer Compositions 1-3, in said MAC system. The retrofitting methods of according to this paragraph are sometimes referred to herein for convenience as Retrofitting Method 2A.

The present invention also includes methods of retrofitting existing MAC systems that contain R134a and existing base-line miscibility PAG lubricant with more environmentally desirable refrigerants comprising HFO-1234yf, said retrofitting methods comprising: (a) ensuring that the existing MAC system is essentially free of the existing R134a refrigerant without taking steps to remove any existing base-line miscibility PAG lubricant that remains in the system after said R134a removal; (b) after said ensuring step (a), introducing into the system a supplemental PAG lubricant composition, wherein the amount of said supplemental PAG lubricant introduced is from about 5% to about 20% of the design lubricant load of the system, wherein the supplemental PAG lubricant composition comprises a dispersant to produce a heat transfer composition of the present invention, including each of Heat Transfer Compositions 1-3, in said MAC system. The retrofitting methods of according to this paragraph are sometimes referred to herein for convenience as Retrofitting Method 2B.

The present invention also includes methods of retrofitting existing MAC systems that contain R134a and existing base-line miscibility PAG lubricant with more environmentally desirable refrigerants comprising HFO-1234yf, said retrofitting methods comprising: (a) ensuring that the existing MAC system is essentially free of the existing R134a refrigerant without taking steps to remove any existing base-line miscibility PAG lubricant that remains in the system after said R134a removal; (b) after said ensuring step (a), introducing into the system a supplemental PAG lubricant composition, wherein the amount of said supplemental PAG lubricant introduced is from about 5% to about 20% of the design lubricant load of the system, wherein the supplemental PAG lubricant composition comprises a high miscibility PAG lubricant and dispersant to produce a heat transfer composition of the present invention, including each of Heat Transfer Compositions 1-3, in said MAC system. The retrofitting methods of according to this paragraph are sometimes referred to herein for convenience as Retrofitting Method 2C.

The present invention includes retrofitted MAC systems that had contained R134a and an existing PAG lubricant, said systems comprising a heat transfer composition of the present invention, including each of Heat Transfer Compositions 1-3. The retrofitted MAC systems according to this paragraph are sometimes referred to herein for convenience as Retrofitted System 1.

The present invention also includes supplemental lubricant packages for use in retrofitting heat transfer systems containing R134a and existing PAG lubricant, said supplemental lubricant package comprising:
(a) supplemental PAG lubricant that can be the same as or different than said existing PAG lubricant; and
(b) dispersing agent present in the supplemental lubricant package in an amount of from about 20% by weight to about 80% by weight based on the weight of said supplemental PAG lubricant and said dispersant.
   The lubricant package according to this paragraph is sometimes referred to herein for convenience as Lubricant Package 1A.

The present invention also includes supplemental lubricant packages for use in retrofitting heat transfer systems containing R134a and existing PAG lubricant, said supplemental lubricant package comprising:
(a) supplemental PAG lubricant that can be the same as or different than said existing PAG lubricant; and
(b) dispersing agent comprising one or more succinimide based and/or succinamine based dispersing agent and/or one or more ethoxylated amine dispersing agents, wherein said dispersing agent is present in the supplemental lubricant package in an amount of from about 20% by weight to about 80% by weight based on the weight of said supplemental PAG lubricant and said dispersant.
   The lubricant package according to this paragraph is sometimes referred to herein for convenience as Lubricant Package 1B.

The present invention also includes supplemental lubricant packages for use in retrofitting heat transfer systems containing R134a and existing PAG lubricant, said supplemental lubricant package comprising:
(a) supplemental PAG lubricant that can be the same as or different than said existing PAG lubricant; and
(b) dispersing agent comprising one or more polyalkylsuccinamide-polyamine based agents and/or one or more polyalkylsuccinimide-polyamine based dispersing agents and/or one or more ethoxylated amine dispersing agents, wherein said dispersing agent is present in the supplemental lubricant package in an amount of from about 20% by weight to about 80% by weight based on the weight of said supplemental PAG lubricant and said dispersant.
   The lubricant package according to this paragraph is sometimes referred to herein for convenience as Lubricant Package 1C.

The present invention also includes supplemental lubricant packages for use in retrofitting heat transfer systems containing R134a and existing base-line miscibility PAG lubricant, said supplemental lubricant package comprising:
(a) supplemental PAG lubricant that is a high miscibility PAG lubricant; and
(b) dispersing agent comprising one or more polyalkylsuccinamide-polyamine based agents and/or one or more polyalkylsuccinimide-polyamine based dispersing agents and/or one or more ethoxylated amine dispersing agents, wherein said dispersing agent is present in the supplemental lubricant package in an amount of from about 20% by weight to about 80% by weight based on the weight of said supplemental PAG lubricant and said dispersant.
   The lubricant package according to this paragraph is sometimes referred to herein for convenience as Lubricant Package 1D.

### Description

### Definitions

As used herein, the term “base-line miscibility PAG lubricant” means those PAG compressor lubricants which, when combined with 1234yf in amounts of from about 0.01% by weight to about 10% by weight of PAG lubricant based on the weight of the PAG lubricant and 1234yf, do not form a single phase fluid over the temperature range of from about −10° C. to about 55° C.

As used herein, the term “high miscibility PAG lubricant” means those PAG compressor lubricants which, when combined with 1234yf in amounts of from about 0.01% by weight to about 10% by weight of PAG lubricant based on the weight of the PAG lubricant and 1234yf, do form a single phase fluid over the temperature range of from about −10° C. to about 55° C.

For the purposes of this invention, the term “about” in relation to temperatures in degrees centigrade (° C.) means that the stated temperature can vary by an amount of +/−10 relative percent of the indicated value. Thus, for example, reference to a temperature of “about 10° C.” covers temperatures of 10° C.+/−1° C., and reference to a temperature of “about 20° C.” covers temperatures of 20° C.+/−2° C.

For the purposes of this invention, the term “about” in relation to amounts of components by weight percent means that the stated weight percent can vary by an amount of +/−10 relative percent of the indicated value. Thus, for example, reference to a weight of “about 10%” covers amount of 10%+/−1%, and reference to an amount of “about 20%” covers amounts of 20%+/−2%.

As the term is used herein, “retrofit” with respect to an existing heat transfer system means that a substantial portion of the existing refrigerant is removed from the heat transfer system and replaced with the new refrigerant without the need for a change to or replacement of any substantial item of equipment in the system to accommodate the new refrigerant, and the existing system that heretofore had been commonly used with that prior refrigerant.

The phrase “Global Warming Potential” (hereinafter “GWP”) was developed to allow comparisons of the global warming impact of different gases. Specifically, it is a measure of how much energy the emission of one ton of a gas will absorb over a given period of time, relative to the emission of one ton of carbon dioxide. The larger the GWP, the more that a given gas warms the Earth compared to CO2 over that time period. The time period usually used for GWP is 100 years. GWP provides a common measure, which allows analysts to add up emission estimates of different gases. See www.epa.gov.

The terms “1234yf” and “HFO-1234yf,” and “R1234yf” as used herein each means 2,3,3,3-tetrafluoropropene.

The terms “R-134a” and “HFC-134a” as used herein each means 1,1,1,2-tetrafluoroethane.

As used herein, reference to a defined group, such as “Heat Transfer Compositions 1-3,” refers to each composition within that group, including wherein a definition number includes a suffix. For example, reference to “Lubricant Package 1” is intended to include each lubricant package within that group, including Lubricant Package 1A, Lubricant Package 1B, Lubricant Package 1C and Lubricant Package 1D.

### Heat Transfer Compositions

Applicants have found that the heat transfer compositions of the present invention, including each of Heat Transfer Compositions 1-3, are capable of providing exceptionally advantageous

Although it is contemplated that amount of PAG lubricant in the present heat transfer composition can vary generally from about 0.01% by weight to about 10% by weight based on the weight of the refrigerant and the lubricant while maintaining a single phase fluid over the temperature range of from about −10° C. to about 55° C., in some embodiments of the present invention the amount of PAG lubricant in the present heat transfer compositions can be up to about 15% by weight based on the weight of the refrigerant and the lubricant while still maintaining a single phase fluid over the temperature range of from about −10° C. to about 55° C.

It is contemplated that the type of PAG lubricant in the present heat transfer compositions, and the PAG lubricants that is present in accordance with the present retrofit systems and methods, can vary widely within the broad scope of the present invention. However, the PAG lubricant in preferred embodiments of the present heat transfer composition, including Heat Transfer Compositions 1-3, comprises or consists essentially of base-line miscibility PAG lubricants as described below. In this regard it is noted that in such preferred heat transfer compositions formed as a result of implementing the retrofitting methods of the present invention may include as much as about 20% by weight of high miscibility lubricant, such heat transfer compositions are considered to consist essentially of base-line miscibility PAG lubricants according to the present invention.

### Pag Lubricant

Generally speaking, the PAG lubricant of the present invention includes in preferred embodiments one or more polar, oxygenated compounds. Preferred polar, oxygenated compounds include polyalkylene oxides also known as polyalkylene glycols (PAGs).

The preferred PAG lubricants that are preferred to be present according to the present heat transfer compositions, including each of Heat Transfer Compositions 1-3, and as the existing PAG lubricants in the present retrofit methods, including each of Retrofitting Methods 1-2, are those PAG lubricants which, when combined with 1234yf in an amount of from about 0.01% by weight to about 10% by weight of PAG lubricant based on the weight of the PAG lubricant and 1234yf, do not form a single phase fluid over the temperature range of from about −10° C. to about 55° C.

Thus, in preferred embodiments of the present heat transfer compositions, including each of Heat Transfer Compositions 1-3, the PAG lubricant comprises or consists essentially of base-line miscibility PAG lubricant.

Further, in preferred embodiments of the retrofitting methods, including each of Retrofitting Methods 1-2, the PAG lubricant comprises or consists essentially of base-line miscibility PAG lubricant.

Generally speaking, the polyalkylene glycol lubricants (PAG lubricants) of the present invention include compounds containing more than one alkylene oxide wherein one or more of the ends are opened with a moiety (group) that does not contain an active hydrogen atom. Any alkylene oxide which facilitates lubrication can be used with ethylene oxide and propylene oxide being preferred and propylene oxide more preferred. End capping moieties include any moiety which does not interfere with lubrication or refrigeration. Preferred end capping moieties include lower alkyl groups; with C1 to C4 lower alkyl groups more preferred. Preferred PAG lubricants include one or any combination of alkyl ether capped compounds, ester capped compounds or monols that have at least a single hydroxyl group. Preferred alkylene glycols are single end capped or double end capped.

The PAG lubricant may have a wide variety of viscosity values, and all such lubricants are withing the broad scope hereof, including but not limited to a kinematic viscosity (measured at 40° C., according to ASTM D445) greater than about 5 cSt, or greater than about 10 cSt, or greater than 20 cSt. The PAG lubricant may have a kinematic viscosity (measured at 40° C., according to ASTM D445) that includes less than about 600 cSt, or less than about 320 cSt, or less 210 cSt. The lubricant, when measured at 40° C., according to ASTM D445, preferably in many embodiments has kinematic viscosity between about 30 and about 60 cSt, or between about 35 and about 55 cSt, or between about 40 and about 50 cSt.

The PAG lubricant may have a wide variety of molecular weights, and all such lubricants are withing the broad scope hereof, including but not limited to molecular weight (as measured by Gel Permeation Chromatography (GPC) or Time of Flight Mass Spectrometry (TOF-MS) between about 1000 and about 4000, or between about 1500 and about 3500.

As mentioned above, the preferred base-line miscibility PAG lubricants which are present in the existing R134a MAC system of the present invention include, but are not limited to, the lubricants in the following Table:

| | | Kinematic Viscosity |
|---|---|---|
| PAG Lubricant | | @ at 40° C., according |
| Tradename | Manufacturer | to ASTM D445) |
| RL897 | DuPont Mobility | 44-48 |
| | and Materials | |
| SP-15 | Dow | 44-48 |
| SP-10 | Idimitsu | 44-48 |
| ND-8 | Idimitsu | 44-48 |

A base-line miscibility PAG lubricant having a kinematic viscosity at 40° C. measured in accordance with ASTM D445 of from about 30 cSt to about 60 cSt is referred to herein as Base-line miscibility PAG Lubricant 1A.

A base-line miscibility PAG lubricant having a kinematic viscosity at 40° C. measured in accordance with ASTM D445 of from about 35 cSt to about 55 cSt is referred to herein as Base-line miscibility PAG Lubricant 1B.

A base-line miscibility PAG lubricant having a kinematic viscosity at 40° C. measured in accordance with ASTM D445 of from about 40 cSt to about 50 cSt is referred to herein as Base-line miscibility PAG Lubricant 1C.

A base-line miscibility PAG lubricant having a kinematic viscosity at 40° C. measured in accordance with ASTM D445 of from about 46 cSt is referred to herein as Base-line miscibility PAG Lubricant 1D.

In preferred embodiments, the present heat transfer compositions, including each of Heat Transfer Compositions 1-3, comprise a PAG lubricant which comprises Base-line miscibility PAG Lubricant 1A.

In preferred embodiments, the present heat transfer compositions, including each of Heat Transfer Compositions 1-3, comprise a PAG lubricant which consist essentially of Base-line miscibility PAG Lubricant 1A.

In preferred embodiments, the present retrofit methods, including each of Retrofit Methods 1-2, comprise a said existing PAG lubricant comprising Base-line miscibility PAG Lubricant 1A.

In preferred embodiments, the present retrofit methods, including each of Retrofit Methods 1-2, comprise a said existing PAG lubricant consist essentially of Base-line miscibility PAG Lubricant 1A.

In preferred embodiments, the present retrofitted MAC systems, including Retrofitted System 1, comprise said PAG lubricant comprising Base-line miscibility PAG Lubricant 1A.

In preferred embodiments, the present retrofitted MAC systems, including Retrofitted System 1, comprise said PAG lubricant consist essentially of Base-line miscibility PAG Lubricant 1A.

In preferred embodiments, the present heat transfer compositions, including each of Heat Transfer Compositions 1-3, comprise a PAG lubricant which comprises Base-line miscibility PAG Lubricant 1B.

In preferred embodiments, the present heat transfer compositions, including each of Heat Transfer Compositions 1-3, comprise a PAG lubricant which consist essentially of Base-line miscibility PAG Lubricant 1B.

In preferred embodiments, the present retrofit methods, including each of Retrofit Methods 1-2, comprise a said existing PAG lubricant comprising Base-line miscibility PAG Lubricant 1B.

In preferred embodiments, the present retrofit methods, including each of Retrofit Methods 1-2, comprise a said existing PAG lubricant consist essentially of Base-line miscibility PAG Lubricant 1B.

In preferred embodiments, the present retrofitted MAC systems, including Retrofitted System 1, comprise said PAG lubricant comprising Base-line miscibility PAG Lubricant 1B.

In preferred embodiments, the present retrofitted MAC systems, including Retrofitted System 1, comprise said PAG lubricant consist essentially of Base-line miscibility PAG Lubricant 1B.

In preferred embodiments, the present heat transfer compositions, including each of Heat Transfer Compositions 1-3, comprise a PAG lubricant which comprises Base-line miscibility PAG Lubricant 1C.

In preferred embodiments, the present heat transfer compositions, including each of Heat Transfer Compositions 1-3, comprise a PAG lubricant which consist essentially of Base-line miscibility PAG Lubricant 1C.

In preferred embodiments, the present retrofit methods, including each of Retrofit Methods 1-2, comprise a said existing PAG lubricant comprising Base-line miscibility PAG Lubricant 1C.

In preferred embodiments, the present retrofit methods, including each of Retrofit Methods 1-2, comprise a said existing PAG lubricant consist essentially of Base-line miscibility PAG Lubricant 1C.

In preferred embodiments, the present retrofitted MAC systems, including Retrofitted System 1, comprise said PAG lubricant comprising Base-line miscibility PAG Lubricant 1C.

In preferred embodiments, the present retrofitted MAC systems, including Retrofitted System 1, comprise said PAG lubricant consist essentially of Base-line miscibility PAG Lubricant 1C.

In preferred embodiments, the present heat transfer compositions, including each of Heat Transfer Compositions 1-3, comprise a PAG lubricant which comprises Base-line miscibility PAG Lubricant 1D.

In preferred embodiments, the present heat transfer compositions, including each of Heat Transfer Compositions 1-3, comprise a PAG lubricant which consist essentially of Base-line miscibility PAG Lubricant 1D.

In preferred embodiments, the present retrofit methods, including each of Retrofit Methods 1-2, comprise a said existing PAG lubricant comprising Base-line miscibility PAG Lubricant 1D.

In preferred embodiments, the present retrofit methods, including each of Retrofit Methods 1-2, comprise a said existing PAG lubricant consist essentially of Base-line miscibility PAG Lubricant 1D.

In preferred embodiments, the present retrofitted MAC systems, including Retrofitted System 1, comprise said PAG lubricant comprising Base-line miscibility PAG Lubricant 1D.

In preferred embodiments, the present retrofitted MAC systems, including Retrofitted System 1, comprise said PAG lubricant consist essentially of Base-line miscibility PAG Lubricant 1D.

The heat transfer compositions of the invention may include other components for the purpose of enhancing or providing certain functionality to the compositions, preferably without negating the enhanced stability provided in accordance with present invention. Other components or additives may include dyes, solubilizing agents, surfactants, dispersants, compatibilizers, auxiliary stabilizers, antioxidants, corrosion inhibitors, extreme pressure additives and anti-wear additives.

### Dispersants

Applicants have surprisingly and unexpectedly found that the present heat transfer compositions, including each of Heat Transfer Compositions 1-3, have tremendous advantage, particularly as formed by the present retrofitting methods, including Retrofitting Methods 1-3, with the use of dispersants according to the present invention.

The preferred dispersants according to the present heat transfer compositions, including each of Heat Transfer Compositions 1-3, and in accordance with the present retrofit methods, including each of Retrofitting Methods 1-2, are those dispersants which are effective to ensure that the combination of R1234yf and the PAG lubricant, including base-line miscibility lubricants, is a single phase fluid over the temperature range of from about −10° C. to about 55° C.

In preferred embodiments, applicants have found that the dispersant is present in the heat transfer compositions of the present invention, including each of Heat Transfer Compositions 1-3, and in accordance with the present retrofit methods, including each of Retrofitting Methods 1-2, in an amount that is greater than 1% and up to about 5% by weight based on the weight of the PAG lubricant and the dispersant. In highly preferred embodiments, the present invention includes a critical range of dispersant in which the dispersant is present in amounts of greater than 2.5% and up to about 5% by weight based on the weight of the PAG lubricant and the dispersant. Applicants have found that in such preferred embodiments this is a critical range in that amounts of 1% or less, or in some embodiments 2.5% or less, the desired effectiveness is not fully achieved for some base-line PAG lubricants and that amounts of greater than 5% do not substantially improve miscibility performance.

In preferred embodiments, the dispersant comprises one or more polyalkylsuccinimide based materials and/or polyalkylsuccinamide based materials that have dispersant activity, and preferably polyisobutylsuccinimide based materials. Such materials are generally disclosed in the following, each of which is incorporated herein by reference: US 2015/0024984, US 2008/0307698.

In preferred embodiments the dispersant comprises a polyaklysuccinamide-polyamine (hereinafter sometimes referred to herein for convenience as PASI-PAM).

In preferred embodiments the PASI-PAM dispersant comprises a polyisobutylsuccinamide-polyamine (hereinafter sometimes referred to herein for convenience as PIBSI-PAM). One preferred example of a PIBSI-PAM dispersant according to the present invention is generally in accordance with the following structure:

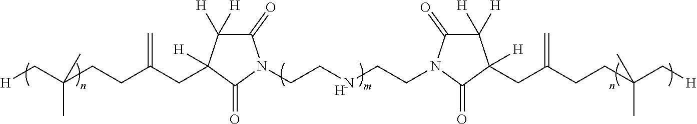

For convenience, PIBSI-PAM compounds having the above structure are referred to herein as PIBSI-PAM-F1.

In preferred embodiments the PASI-PAM dispersant comprises a capped PASI-PAM, meaning that one or more of NH groups in the compound are replaced by a less reactive functional group. For example, a preferred capped PIBSI-PAM is illustrated below, in which one or more of the NH groups in the secondary amine(s) connecting the succinimide groups is canned hv reaction with ethylene carbondate.

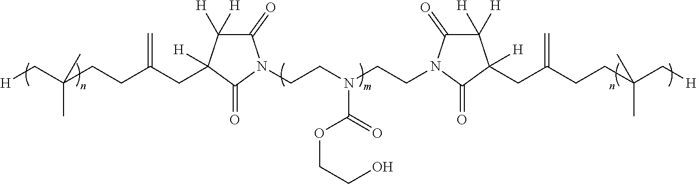

For convenience, PIBSI-PAM compounds having the above structure are referred to herein as PIBSI-PAM-F2.

Some examples of the preparation and characteristics of such materials are described in the following, each of which is incorporated herein by reference: U.S. Pat. No. 6,770,605 and in “Chemical Modification of Polyisobutylene Succinimide Dispersants and Characterization of their Associative Properties,” Pirouz, et. al.

In preferred embodiments, the dispersant comprises one or more amine ethoxylate based materials that have dispersant activity, sometimes referred to herein for convenience as AE. Preferably, the amine ethoxylate has a basic structure as follows:

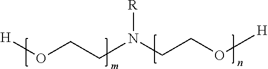

Where each of m and n can independently vary from 0 to 20, provided that m+n must be at lease one (in which case the amine is mono ethoxylated, which is sometimes referred to herein for convenience as mEA). In the case where m+n is greater than 1, the amine ethoxylate is a polyethoxylated amine (in which case the amine is mono ethoxylated, which is sometimes referred to herein for convenience as pEA). R is a hydrocarbon chain having from 1 to 25 carbon atoms, preferably from 10 to 20 carbon atoms. In preferred embodiments, R has a chain length of about 18.

In preferred embodiments, the dispersant can comprise one or more amine ethoxylate based materials and one or more polyalkylsuccinamide based materials.

The following Table DM provides for convenience a summary of the above noted preferred dispersant types and compounds, including their abbreviations as used herein:

TABLE DM

| Dispersant Material | Abreviation |
|---|---|
| polyalkylsuccinimide based | PASI |
| polyalkylsuccinamide based | PASA |
| polyisobutylsuccinimide based | PIBSI |
| polyisobutyllsuccinamide based | PIBSA |
| polyisobutylsuccinimide-polyamine | PIBSI-PAM |
| Polyisobutyllsuccinamide-polyamine | PIBSA-PAM |
| polyisobutylsuccinamide-polyamine-F1 | PIBSI-PAM-F1 |
| Polyisobutylsuccinamide-polyamine-F2 | PIBSA-PAM-F2 |
| amine ethoxylate | AE |
| monoethoxylate amine | mAE |
| Polyethoxylated amine | pAE |
| Ethoxylated amine with R having | AE-C18 |
| a chain length of about 18 | |
| monoethoxylate amine with R having | mAE-C18 |
| a chain length of about 18 | |
| Polyethoxylated amine with R having | pAE-C18 |
| a chain length of about 18 | |

Applicants have found that the heat transfer compositions of the present invention, including each of Heat Transfer Compositions 1-3 as described herein, are capable of providing exceptionally advantageous properties and in particular providing high levels of miscibility in use, including in retrofitting methods such as each of Retrofitting Methods 1-2.

Particular heat transfer compositions of the present invention include those identified in the following Table HTC, wherein the first column of the table includes “HTC” as an abbreviation for a defined Heat Transfer Composition. In Table 1 below: “NR” means that the component or an particular amount is “not required” according to the specified HTC definition and as such its presence in any amount or in no amount is permitted; “Yes” means the component is required but that any type or amount is permitted; “Comp” means that the specified composition comprises the items identified in the table; “CEO” means that the specified composition consists essentially of the items identified in the table; “CO” means that composition consists of the items identified in the table; BLVPAG means base-line viscosity PAG; the column heading “Refrigerant, wt %” indicates that the heat transfer composition comprises the indicated refrigerant and when present the amount of the indicated refrigerant as a percentage of the refrigerant components in the heat transfer composition; the column heading Lubricant indicates the heat transfer composition comprises the type or category of lubricant as defined herein; the column heading Lubricant Amount indicates the amount of the indicated lubricant as a percentage of heat transfer components; defined herein; the column heading Dispersant indicates that the heat transfer composition comprises the dispersant or the type or category of dispersant; the column heading “Dispersant Amount, wt %” means the amount of the indicated dispersant as a weight percentage of the lubricant plus dispersant; and all amounts are understood to be preceded by the word “about.”

TABLE HTC

| HTC | | Refrigerant, | | Lubricant | | Dispersant |
|---|---|---|---|---|---|---|
| No. | | wt % | Lubricant | Amount, wt % | Dispersant | Amount, wt % |
| 4A | Comp | 1234yf => 50 | PAG | 0.01-10 | PASI | NR |
| 4B | CEO | 1234yf => 50 | PAG | 0.01-10 | PASI | NR |
| 4C | Comp | 1234yf => 75 | PAG | 0.01-10 | PASI | NR |
| 4D | CEO | 1234yf => 75 | PAG | 0.01-10 | PASI | NR |
| 4E | Comp | 1234yf => 95 | PAG | 0.01-10 | PASI | NR |
| 4F | CEO | 1234yf => 95 | BLVPAG | 0.01-10 | PASI | NR |
| 4G | Comp | 1234yf => 50 | BLVPAG | 0.01-10 | PASI | NR |
| 4H | CEO | 1234yf => 50 | BLVPAG | 0.01-10 | PASI | NR |
| 4I | Comp | 1234yf => 75 | BLVPAG | 0.01-10 | PASI | NR |
| 4J | CEO | 1234yf => 75 | BLVPAG | 0.01-10 | PASI | NR |
| 4K | Comp | 1234yf => 95 | BLVPAG | 0.01-10 | PASI | NR |
| 4L | CEO | 1234yf => 95 | BLVPAG | 0.01-10 | PASI | NR |
| 4M | CEO | 1234yf => 95 | BLVPAG | 0.01-10 | PASI | >1 to 5 |
| 4N | Comp | 1234yf => 50 | BLVPAG | 0.01-10 | PASI | >1 to 5 |
| 4O | CEO | 1234yf => 50 | BLVPAG | 0.01-10 | PASI | >1 to 5 |
| 4P | Comp | 1234yf => 75 | BLVPAG | 0.01-10 | PASI | >1 to 5 |
| 4Q | CEO | 1234yf => 75 | BLVPAG | 0.01-10 | PASI | >1 to 5 |
| 4R | Comp | 1234yf => 95 | BLVPAG | 0.01-10 | PASI | >1 to 5 |
| 4S | CEO | 1234yf => 95 | BLVPAG | 0.01-10 | PASI | >1 to 5 |
| 4T | CEO | 1234yf => 95 | BLVPAG | 0.01-10 | PASI | 2.5-5 |
| 5A | Comp | 1234yf => 50 | PAG | 0.01-10 | PASA | NR |
| 5B | CEO | 1234yf => 50 | PAG | 0.01-10 | PASA | NR |
| 5C | Comp | 1234yf => 75 | PAG | 0.01-10 | PASA | NR |
| 5D | CEO | 1234yf => 75 | PAG | 0.01-10 | PASA | NR |
| 5E | Comp | 1234yf => 95 | PAG | 0.01-10 | PASA | NR |
| 5F | CEO | 1234yf => 95 | BLVPAG | 0.01-10 | PASA | NR |
| 5G | Comp | 1234yf => 50 | BLVPAG | 0.01-10 | PASA | NR |
| 5H | CEO | 1234yf => 50 | BLVPAG | 0.01-10 | PASA | NR |
| 5I | Comp | 1234yf => 75 | BLVPAG | 0.01-10 | PASA | NR |
| 5J | CEO | 1234yf => 75 | BLVPAG | 0.01-10 | PASA | NR |
| 5K | Comp | 1234yf => 95 | BLVPAG | 0.01-10 | PASA | NR |
| 5L | CEO | 1234yf => 95 | BLVPAG | 0.01-10 | PASA | NR |
| 5M | CEO | 1234yf => 95 | BLVPAG | 0.01-10 | PASA | >1 to 5 |
| 5N | Comp | 1234yf => 50 | BLVPAG | 0.01-10 | PASA | >1 to 5 |
| 5O | CEO | 1234yf => 50 | BLVPAG | 0.01-10 | PASA | >1 to 5 |
| 5P | Comp | 1234yf => 75 | BLVPAG | 0.01-10 | PASA | >1 to 5 |
| 5Q | CEO | 1234yf => 75 | BLVPAG | 0.01-10 | PASA | >1 to 5 |
| 5R | Comp | 1234yf => 95 | BLVPAG | 0.01-10 | PASA | >1 to 5 |
| 5S | CEO | 1234yf => 95 | BLVPAG | 0.01-10 | PASA | >1 to 5 |
| 5T | CEO | 1234yf => 95 | BLVPAG | 0.01-10 | PASA | 2.5-5 |
| 6A | Comp | 1234yf => 50 | PAG | 0.01-10 | PIBSI | NR |
| 6B | CEO | 1234yf => 50 | PAG | 0.01-10 | PIBSI | NR |
| 6C | Comp | 1234yf => 75 | PAG | 0.01-10 | PIBSI | NR |
| 6D | CEO | 1234yf => 75 | PAG | 0.01-10 | PIBSI | NR |
| 6E | Comp | 1234yf => 95 | PAG | 0.01-10 | PIBSI | NR |
| 6F | CEO | 1234yf => 95 | BLVPAG | 0.01-10 | PIBSI | NR |
| 6G | Comp | 1234yf => 50 | BLVPAG | 0.01-10 | PIBSI | NR |
| 6H | CEO | 1234yf => 50 | BLVPAG | 0.01-10 | PIBSI | NR |
| 6I | Comp | 1234yf => 75 | BLVPAG | 0.01-10 | PIBSI | NR |
| 6J | CEO | 1234yf => 75 | BLVPAG | 0.01-10 | PIBSI | NR |
| 6K | Comp | 1234yf => 95 | BLVPAG | 0.01-10 | PIBSI | NR |
| 6L | CEO | 1234yf => 95 | BLVPAG | 0.01-10 | PIBSI | NR |
| 6M | CEO | 1234yf => 95 | BLVPAG | 0.01-10 | PIBSI | >1 to 5 |
| 6N | Comp | 1234yf => 50 | BLVPAG | 0.01-10 | PIBSI | >1 to 5 |
| 6O | CEO | 1234yf => 50 | BLVPAG | 0.01-10 | PIBSI | >1 to 5 |
| 6P | Comp | 1234yf => 75 | BLVPAG | 0.01-10 | PIBSI | >1 to 5 |
| 6Q | CEO | 1234yf => 75 | BLVPAG | 0.01-10 | PIBSI | >1 to 5 |
| 6R | Comp | 1234yf => 95 | BLVPAG | 0.01-10 | PIBSI | >1 to 5 |
| 6S | CEO | 1234yf => 95 | BLVPAG | 0.01-10 | PIBSI | >1 to 5 |
| 6T | CEO | 1234yf => 95 | BLVPAG | 0.01-10 | PIBSI | 2.5-5 |
| 7A | Comp | 1234yf => 50 | PAG | 0.01-10 | PIBSA | NR |
| 7B | CEO | 1234yf => 50 | PAG | 0.01-10 | PIBSA | NR |
| 7C | Comp | 1234yf => 75 | PAG | 0.01-10 | PIBSA | NR |
| 7D | CEO | 1234yf => 75 | PAG | 0.01-10 | PIBSA | NR |
| 7E | Comp | 1234yf => 95 | PAG | 0.01-10 | PIBSA | NR |
| 7F | CEO | 1234yf => 95 | BLVPAG | 0.01-10 | PIBSA | NR |
| 7G | Comp | 1234yf => 50 | BLVPAG | 0.01-10 | PIBSA | NR |
| 7H | CEO | 1234yf => 50 | BLVPAG | 0.01-10 | PIBSA | NR |
| 7I | Comp | 1234yf => 75 | BLVPAG | 0.01-10 | PIBSA | NR |
| 7J | CEO | 1234yf => 75 | BLVPAG | 0.01-10 | PIBSA | NR |
| 7K | Comp | 1234yf => 95 | BLVPAG | 0.01-10 | PIBSA | NR |
| 7L | CEO | 1234yf => 95 | BLVPAG | 0.01-10 | PIBSA | NR |
| 7M | CEO | 1234yf => 95 | BLVPAG | 0.01-10 | PIBSA | >1 to 5 |
| 7N | Comp | 1234yf => 50 | BLVPAG | 0.01-10 | PIBSA | >1 to 5 |
| 7O | CEO | 1234yf => 50 | BLVPAG | 0.01-10 | PIBSA | >1 to 5 |
| 7P | Comp | 1234yf => 75 | BLVPAG | 0.01-10 | PIBSA | >1 to 5 |
| 7Q | CEO | 1234yf => 75 | BLVPAG | 0.01-10 | PIBSA | >1 to 5 |
| 7R | Comp | 1234yf => 95 | BLVPAG | 0.01-10 | PIBSA | >1 to 5 |
| 7S | CEO | 1234yf => 95 | BLVPAG | 0.01-10 | PIBSA | >1 to 5 |
| 7T | CEO | 1234yf => 95 | BLVPAG | 0.01-10 | PIBSA | 2.5-5 |
| 8A | Comp | 1234yf => 50 | PAG | 0.01-10 | PIBSI-PAM | NR |
| 8B | CEO | 1234yf => 50 | PAG | 0.01-10 | PIBSI-PAM | NR |
| 8C | Comp | 1234yf => 75 | PAG | 0.01-10 | PIBSI-PAM | NR |
| 8D | CEO | 1234yf => 75 | PAG | 0.01-10 | PIBSI-PAM | NR |
| 8E | Comp | 1234yf => 95 | PAG | 0.01-10 | PIBSI-PAM | NR |
| 8F | CEO | 1234yf => 95 | BLVPAG | 0.01-10 | PIBSI-PAM | NR |
| 8G | Comp | 1234yf => 50 | BLVPAG | 0.01-10 | PIBSI-PAM | NR |
| 8H | CEO | 1234yf => 50 | BLVPAG | 0.01-10 | PIBSI-PAM | NR |
| 8I | Comp | 1234yf => 75 | BLVPAG | 0.01-10 | PIBSI-PAM | NR |
| 8J | CEO | 1234yf => 75 | BLVPAG | 0.01-10 | PIBSI-PAM | NR |
| 8K | Comp | 1234yf => 95 | BLVPAG | 0.01-10 | PIBSI-PAM | NR |
| 8L | CEO | 1234yf => 95 | BLVPAG | 0.01-10 | PIBSI-PAM | NR |
| 8M | CEO | 1234yf => 95 | BLVPAG | 0.01-10 | PIBSI-PAM | >1 to 5 |
| 8N | Comp | 1234yf => 50 | BLVPAG | 0.01-10 | PIBSI-PAM | >1 to 5 |
| 8O | CEO | 1234yf => 50 | BLVPAG | 0.01-10 | PIBSI-PAM | >1 to 5 |
| 8P | Comp | 1234yf => 75 | BLVPAG | 0.01-10 | PIBSI-PAM | >1 to 5 |
| 8Q | CEO | 1234yf => 75 | BLVPAG | 0.01-10 | PIBSI-PAM | >1 to 5 |
| 8R | Comp | 1234yf => 95 | BLVPAG | 0.01-10 | PIBSI-PAM | >1 to 5 |
| 8S | CEO | 1234yf => 95 | BLVPAG | 0.01-10 | PIBSI-PAM | >1 to 5 |
| 8T | CEO | 1234yf => 95 | BLVPAG | 0.01-10 | PIBSI-PAM | 2.5-5 |
| 9A | Comp | 1234yf => 50 | PAG | 0.01-10 | PIBSA-PAM | NR |
| 9B | CEO | 1234yf => 50 | PAG | 0.01-10 | PIBSA-PAM | NR |
| 9C | Comp | 1234yf => 75 | PAG | 0.01-10 | PIBSA-PAM | NR |
| 9D | CEO | 1234yf => 75 | PAG | 0.01-10 | PIBSA-PAM | NR |
| 9E | Comp | 1234yf => 95 | PAG | 0.01-10 | PIBSA-PAM | NR |
| 9F | CEO | 1234yf => 95 | BLVPAG | 0.01-10 | PIBSA-PAM | NR |
| 9G | Comp | 1234yf => 50 | BLVPAG | 0.01-10 | PIBSA-PAM | NR |
| 9H | CEO | 1234yf => 50 | BLVPAG | 0.01-10 | PIBSA-PAM | NR |
| 9I | Comp | 1234yf => 75 | BLVPAG | 0.01-10 | PIBSA-PAM | NR |
| 9J | CEO | 1234yf => 75 | BLVPAG | 0.01-10 | PIBSA-PAM | NR |
| 9K | Comp | 1234yf => 95 | BLVPAG | 0.01-10 | PIBSA-PAM | NR |
| 9L | CEO | 1234yf => 95 | BLVPAG | 0.01-10 | PIBSA-PAM | NR |
| 9M | CEO | 1234yf => 95 | BLVPAG | 0.01-10 | PIBSA-PAM | >1 to 5 |
| 9N | Comp | 1234yf => 50 | BLVPAG | 0.01-10 | PIBSA-PAM | >1 to 5 |
| 9O | CEO | 1234yf => 50 | BLVPAG | 0.01-10 | PIBSA-PAM | >1 to 5 |
| 9P | Comp | 1234yf => 75 | BLVPAG | 0.01-10 | PIBSA-PAM | >1 to 5 |
| 9Q | CEO | 1234yf => 75 | BLVPAG | 0.01-10 | PIBSA-PAM | >1 to 5 |
| 9R | Comp | 1234yf => 95 | BLVPAG | 0.01-10 | PIBSA-PAM | >1 to 5 |
| 9S | CEO | 1234yf => 95 | BLVPAG | 0.01-10 | PIBSA-PAM | >1 to 5 |
| 9T | CEO | 1234yf => 95 | BLVPAG | 0.01-10 | PIBSA-PAM | 2.5-5 |
| 10A | Comp | 1234yf => 50 | PAG | 0.01-10 | PIBSI-PAMF1 | NR |
| 10B | CEO | 1234yf => 50 | PAG | 0.01-10 | PIBSI-PAMF1 | NR |
| 10C | Comp | 1234yf => 75 | PAG | 0.01-10 | PIBSI-PAMF1 | NR |
| 10D | CEO | 1234yf => 75 | PAG | 0.01-10 | PIBSI-PAMF1 | NR |
| 10E | Comp | 1234yf => 95 | PAG | 0.01-10 | PIBSI-PAMF1 | NR |
| 10F | CEO | 1234yf => 95 | BLVPAG | 0.01-10 | PIBSI-PAMF1 | NR |
| 10G | Comp | 1234yf => 50 | BLVPAG | 0.01-10 | PIBSI-PAMF1 | NR |
| 10H | CEO | 1234yf => 50 | BLVPAG | 0.01-10 | PIBSI-PAMF1 | NR |
| 10I | Comp | 1234yf => 75 | BLVPAG | 0.01-10 | PIBSI-PAMF1 | NR |
| 10J | CEO | 1234yf => 75 | BLVPAG | 0.01-10 | PIBSI-PAMF1 | NR |
| 10K | Comp | 1234yf => 95 | BLVPAG | 0.01-10 | PIBSI-PAMF1 | NR |
| 10L | CEO | 1234yf => 95 | BLVPAG | 0.01-10 | PIBSI-PAMF1 | NR |
| 10M | CEO | 1234yf => 95 | BLVPAG | 0.01-10 | PIBSI-PAMF1 | >1 to 5 |
| 10N | Comp | 1234yf => 50 | BLVPAG | 0.01-10 | PIBSI-PAMF1 | >1 to 5 |
| 10O | CEO | 1234yf => 50 | BLVPAG | 0.01-10 | PIBSI-PAMF1 | >1 to 5 |
| 10P | Comp | 1234yf => 75 | BLVPAG | 0.01-10 | PIBSI-PAMF1 | >1 to 5 |
| 10Q | CEO | 1234yf => 75 | BLVPAG | 0.01-10 | PIBSI-PAMF1 | >1 to 5 |
| 10R | Comp | 1234yf => 95 | BLVPAG | 0.01-10 | PIBSI-PAMF1 | >1 to 5 |
| 10S | CEO | 1234yf => 95 | BLVPAG | 0.01-10 | PIBSI-PAMF1 | >1 to 5 |
| 10T | CEO | 1234yf => 95 | BLVPAG | 0.01-10 | PIBSI-PAMF1 | 2.5-5 |
| 11A | Comp | 1234yf => 50 | PAG | 0.01-10 | PIBSA-PAMF2 | NR |
| 11B | CEO | 1234yf => 50 | PAG | 0.01-10 | PIBSA-PAMF2 | NR |
| 11C | Comp | 1234yf => 75 | PAG | 0.01-10 | PIBSA-PAMF2 | NR |
| 11D | CEO | 1234yf => 75 | PAG | 0.01-10 | PIBSA-PAMF2 | NR |
| 11E | Comp | 1234yf => 95 | PAG | 0.01-10 | PIBSA-PAMF2 | NR |
| 11F | CEO | 1234yf => 95 | BLVPAG | 0.01-10 | PIBSA-PAMF2 | NR |
| 11G | Comp | 1234yf => 50 | BLVPAG | 0.01-10 | PIBSA-PAMF2 | NR |
| 11H | CEO | 1234yf => 50 | BLVPAG | 0.01-10 | PIBSA-PAMF2 | NR |
| 11I | Comp | 1234yf => 75 | BLVPAG | 0.01-10 | PIBSA-PAMF2 | NR |
| 11J | CEO | 1234yf => 75 | BLVPAG | 0.01-10 | PIBSA-PAMF2 | NR |
| 11K | Comp | 1234yf => 95 | BLVPAG | 0.01-10 | PIBSA-PAMF2 | NR |
| 11L | CEO | 1234yf => 95 | BLVPAG | 0.01-10 | PIBSA-PAMF2 | NR |
| 11M | CEO | 1234yf => 95 | BLVPAG | 0.01-10 | PIBSA-PAMF2 | >1 to 5 |
| 11N | Comp | 1234yf => 50 | BLVPAG | 0.01-10 | PIBSA-PAMF2 | >1 to 5 |
| 11O | CEO | 1234yf => 50 | BLVPAG | 0.01-10 | PIBSA-PAMF2 | >1 to 5 |
| 11P | Comp | 1234yf => 75 | BLVPAG | 0.01-10 | PIBSA-PAMF2 | >1 to 5 |
| 11Q | CEO | 1234yf => 75 | BLVPAG | 0.01-10 | PIBSA-PAMF2 | >1 to 5 |
| 11R | Comp | 1234yf => 95 | BLVPAG | 0.01-10 | PIBSA-PAMF2 | >1 to 5 |
| 11S | CEO | 1234yf => 95 | BLVPAG | 0.01-10 | PIBSA-PAMF2 | >1 to 5 |
| 11T | CEO | 1234yf => 95 | BLVPAG | 0.01-10 | PIBSA-PAMF2 | 2.5-5 |
| 12A | Comp | 1234yf => 50 | PAG | 0.01-10 | AE | NR |
| 12B | CEO | 1234yf => 50 | PAG | 0.01-10 | AE | NR |
| 12C | Comp | 1234yf => 75 | PAG | 0.01-10 | AE | NR |
| 12D | CEO | 1234yf => 75 | PAG | 0.01-10 | AE | NR |
| 12E | Comp | 1234yf => 95 | PAG | 0.01-10 | AE | NR |
| 12F | CEO | 1234yf => 95 | BLVPAG | 0.01-10 | AE | NR |
| 12G | Comp | 1234yf => 50 | BLVPAG | 0.01-10 | AE | NR |
| 12H | CEO | 1234yf => 50 | BLVPAG | 0.01-10 | AE | NR |
| 12I | Comp | 1234yf => 75 | BLVPAG | 0.01-10 | AE | NR |
| 12J | CEO | 1234yf => 75 | BLVPAG | 0.01-10 | AE | NR |
| 12K | Comp | 1234yf => 95 | BLVPAG | 0.01-10 | AE | NR |
| 12L | CEO | 1234yf => 95 | BLVPAG | 0.01-10 | AE | NR |
| 12M | CEO | 1234yf => 95 | BLVPAG | 0.01-10 | AE | >1 to 5 |
| 12N | Comp | 1234yf => 50 | BLVPAG | 0.01-10 | AE | >1 to 5 |
| 12O | CEO | 1234yf => 50 | BLVPAG | 0.01-10 | AE | >1 to 5 |
| 12P | Comp | 1234yf => 75 | BLVPAG | 0.01-10 | AE | >1 to 5 |
| 12Q | CEO | 1234yf => 75 | BLVPAG | 0.01-10 | AE | >1 to 5 |
| 12R | Comp | 1234yf => 95 | BLVPAG | 0.01-10 | AE | >1 to 5 |
| 12S | CEO | 1234yf => 95 | BLVPAG | 0.01-10 | AE | >1 to 5 |
| 12T | CEO | 1234yf => 95 | BLVPAG | 0.01-10 | AE | 2.5-5 |
| 13A | Comp | 1234yf => 50 | PAG | 0.01-10 | mAE | NR |
| 13B | CEO | 1234yf => 50 | PAG | 0.01-10 | mAE | NR |
| 13C | Comp | 1234yf => 75 | PAG | 0.01-10 | mAE | NR |
| 13D | CEO | 1234yf => 75 | PAG | 0.01-10 | mAE | NR |
| 13E | Comp | 1234yf => 95 | PAG | 0.01-10 | mAE | NR |
| 13F | CEO | 1234yf => 95 | BLVPAG | 0.01-10 | mAE | NR |
| 13G | Comp | 1234yf => 50 | BLVPAG | 0.01-10 | mAE | NR |
| 13H | CEO | 1234yf => 50 | BLVPAG | 0.01-10 | mAE | NR |
| 13I | Comp | 1234yf => 75 | BLVPAG | 0.01-10 | mAE | NR |
| 13J | CEO | 1234yf => 75 | BLVPAG | 0.01-10 | mAE | NR |
| 13K | Comp | 1234yf => 95 | BLVPAG | 0.01-10 | mAE | NR |
| 13L | CEO | 1234yf => 95 | BLVPAG | 0.01-10 | mAE | NR |
| 13M | CEO | 1234yf => 95 | BLVPAG | 0.01-10 | mAE | >1 to 5 |
| 13N | Comp | 1234yf => 50 | BLVPAG | 0.01-10 | mAE | >1 to 5 |
| 13O | CEO | 1234yf => 50 | BLVPAG | 0.01-10 | mAE | >1 to 5 |
| 13P | Comp | 1234yf => 75 | BLVPAG | 0.01-10 | mAE | >1 to 5 |
| 13Q | CEO | 1234yf => 75 | BLVPAG | 0.01-10 | mAE | >1 to 5 |
| 13R | Comp | 1234yf => 95 | BLVPAG | 0.01-10 | mAE | >1 to 5 |
| 13S | CEO | 1234yf => 95 | BLVPAG | 0.01-10 | mAE | >1 to 5 |
| 13T | CEO | 1234yf => 95 | BLVPAG | 0.01-10 | mAE | 2.5-5 |
| 14A | Comp | 1234yf => 50 | PAG | 0.01-10 | pAE | NR |
| 14B | CEO | 1234yf => 50 | PAG | 0.01-10 | pAE | NR |
| 14C | Comp | 1234yf => 75 | PAG | 0.01-10 | pAE | NR |
| 14D | CEO | 1234yf => 75 | PAG | 0.01-10 | pAE | NR |
| 14E | Comp | 1234yf => 95 | PAG | 0.01-10 | pAE | NR |
| 14F | CEO | 1234yf => 95 | BLVPAG | 0.01-10 | pAE | NR |
| 14G | Comp | 1234yf => 50 | BLVPAG | 0.01-10 | pAE | NR |
| 14H | CEO | 1234yf => 50 | BLVPAG | 0.01-10 | pAE | NR |
| 14I | Comp | 1234yf => 75 | BLVPAG | 0.01-10 | pAE | NR |
| 14J | CEO | 1234yf => 75 | BLVPAG | 0.01-10 | pAE | NR |
| 14K | Comp | 1234yf => 95 | BLVPAG | 0.01-10 | pAE | NR |
| 14L | CEO | 1234yf => 95 | BLVPAG | 0.01-10 | pAE | NR |
| 14M | CEO | 1234yf => 95 | BLVPAG | 0.01-10 | pAE | >1 to 5 |
| 14N | Comp | 1234yf => 50 | BLVPAG | 0.01-10 | pAE | >1 to 5 |
| 14O | CEO | 1234yf => 50 | BLVPAG | 0.01-10 | pAE | >1 to 5 |
| 14P | Comp | 1234yf => 75 | BLVPAG | 0.01-10 | pAE | >1 to 5 |
| 14Q | CEO | 1234yf => 75 | BLVPAG | 0.01-10 | pAE | >1 to 5 |
| 14R | Comp | 1234yf => 95 | BLVPAG | 0.01-10 | pAE | >1 to 5 |
| 14S | CEO | 1234yf => 95 | BLVPAG | 0.01-10 | pAE | >1 to 5 |
| 14T | CEO | 1234yf => 95 | BLVPAG | 0.01-10 | pAE | 2.5-5 |
| 15A | Comp | 1234yf => 50 | PAG | 0.01-10 | AE-C18 | NR |
| 15B | CEO | 1234yf => 50 | PAG | 0.01-10 | AE-C18 | NR |
| 15C | Comp | 1234yf => 75 | PAG | 0.01-10 | AE-C18 | NR |
| 15D | CEO | 1234yf => 75 | PAG | 0.01-10 | AE-C18 | NR |
| 15E | Comp | 1234yf => 95 | PAG | 0.01-10 | AE-C18 | NR |
| 15F | CEO | 1234yf => 95 | BLVPAG | 0.01-10 | AE-C18 | NR |
| 15G | Comp | 1234yf => 50 | BLVPAG | 0.01-10 | AE-C18 | NR |
| 15H | CEO | 1234yf => 50 | BLVPAG | 0.01-10 | AE-C18 | NR |
| 15I | Comp | 1234yf => 75 | BLVPAG | 0.01-10 | AE-C18 | NR |
| 15J | CEO | 1234yf => 75 | BLVPAG | 0.01-10 | AE-C18 | NR |
| 15K | Comp | 1234yf => 95 | BLVPAG | 0.01-10 | AE-C18 | NR |
| 15L | CEO | 1234yf => 95 | BLVPAG | 0.01-10 | AE-C18 | NR |
| 15M | CEO | 1234yf => 95 | BLVPAG | 0.01-10 | AE-C18 | >1 to 5 |
| 15N | Comp | 1234yf => 50 | BLVPAG | 0.01-10 | AE-C18 | >1 to 5 |
| 15O | CEO | 1234yf => 50 | BLVPAG | 0.01-10 | AE-C18 | >1 to 5 |
| 15P | Comp | 1234yf => 75 | BLVPAG | 0.01-10 | AE-C18 | >1 to 5 |
| 15Q | CEO | 1234yf => 75 | BLVPAG | 0.01-10 | AE-C18 | >1 to 5 |
| 15R | Comp | 1234yf => 95 | BLVPAG | 0.01-10 | AE-C18 | >1 to 5 |
| 15S | CEO | 1234yf => 95 | BLVPAG | 0.01-10 | AE-C18 | >1 to 5 |
| 15T | CEO | 1234yf => 95 | BLVPAG | 0.01-10 | AE-C18 | 2.5-5 |
| 16A | Comp | 1234yf => 50 | PAG | 0.01-10 | mAE-C18 | NR |
| 16B | CEO | 1234yf => 50 | PAG | 0.01-10 | mAE-C18 | NR |
| 16C | Comp | 1234yf => 75 | PAG | 0.01-10 | mAE-C18 | NR |
| 16D | CEO | 1234yf => 75 | PAG | 0.01-10 | mAE-C18 | NR |
| 16E | Comp | 1234yf => 95 | PAG | 0.01-10 | mAE-C18 | NR |
| 16F | CEO | 1234yf => 95 | BLVPAG | 0.01-10 | mAE-C18 | NR |
| 16G | Comp | 1234yf => 50 | BLVPAG | 0.01-10 | mAE-C18 | NR |
| 16H | CEO | 1234yf => 50 | BLVPAG | 0.01-10 | mAE-C18 | NR |
| 16I | Comp | 1234yf => 75 | BLVPAG | 0.01-10 | mAE-C18 | NR |
| 16J | CEO | 1234yf => 75 | BLVPAG | 0.01-10 | mAE-C18 | NR |
| 16K | Comp | 1234yf => 95 | BLVPAG | 0.01-10 | mAE-C18 | NR |
| 16L | CEO | 1234yf => 95 | BLVPAG | 0.01-10 | mAE-C18 | NR |
| 16M | CEO | 1234yf => 95 | BLVPAG | 0.01-10 | mAE-C18 | >1 to 5 |
| 16N | Comp | 1234yf => 50 | BLVPAG | 0.01-10 | mAE-C18 | >1 to 5 |
| 16O | CEO | 1234yf => 50 | BLVPAG | 0.01-10 | mAE-C18 | >1 to 5 |
| 16P | Comp | 1234yf => 75 | BLVPAG | 0.01-10 | mAE-C18 | >1 to 5 |
| 16Q | CEO | 1234yf => 75 | BLVPAG | 0.01-10 | mAE-C18 | >1 to 5 |
| 16R | Comp | 1234yf => 95 | BLVPAG | 0.01-10 | mAE-C18 | >1 to 5 |
| 16S | CEO | 1234yf => 95 | BLVPAG | 0.01-10 | mAE-C18 | >1 to 5 |
| 16T | CEO | 1234yf => 95 | BLVPAG | 0.01-10 | mAE-C18 | 2.5-5 |
| 17A | Comp | 1234yf => 50 | PAG | 0.01-10 | pAE-C18 | NR |
| 17B | CEO | 1234yf => 50 | PAG | 0.01-10 | pAE-C18 | NR |
| 17C | Comp | 1234yf => 75 | PAG | 0.01-10 | pAE-C18 | NR |
| 17D | CEO | 1234yf => 75 | PAG | 0.01-10 | pAE-C18 | NR |
| 17E | Comp | 1234yf => 95 | PAG | 0.01-10 | pAE-C18 | NR |
| 17F | CEO | 1234yf => 95 | BLVPAG | 0.01-10 | pAE-C18 | NR |
| 17G | Comp | 1234yf => 50 | BLVPAG | 0.01-10 | pAE-C18 | NR |
| 17H | CEO | 1234yf => 50 | BLVPAG | 0.01-10 | pAE-C18 | NR |
| 17I | Comp | 1234yf => 75 | BLVPAG | 0.01-10 | pAE-C18 | NR |
| 17J | CEO | 1234yf => 75 | BLVPAG | 0.01-10 | pAE-C18 | NR |
| 17K | Comp | 1234yf => 95 | BLVPAG | 0.01-10 | pAE-C18 | NR |
| 17L | CEO | 1234yf => 95 | BLVPAG | 0.01-10 | pAE-C18 | NR |
| 17M | CEO | 1234yf => 95 | BLVPAG | 0.01-10 | pAE-C18 | >1 to 5 |
| 17N | Comp | 1234yf => 50 | BLVPAG | 0.01-10 | pAE-C18 | >1 to 5 |
| 17O | CEO | 1234yf => 50 | BLVPAG | 0.01-10 | pAE-C18 | >1 to 5 |
| 17P | Comp | 1234yf => 75 | BLVPAG | 0.01-10 | pAE-C18 | >1 to 5 |
| 17Q | CEO | 1234yf => 75 | BLVPAG | 0.01-10 | pAE-C18 | >1 to 5 |
| 17R | Comp | 1234yf => 95 | BLVPAG | 0.01-10 | pAE-C18 | >1 to 5 |
| 17S | CEO | 1234yf => 95 | BLVPAG | 0.01-10 | pAE-C18 | >1 to 5 |
| 17T | CEO | 1234yf => 95 | BLVPAG | 0.01-10 | pAE-C18 | 2.5-5 |

### Lubricant Packages

Applicants have found that the lubricant packages of the present invention, including each of Lubricant Packages 1 and Lubricant Packages 2-17 as described hereinafter, are capable of providing exceptionally advantageous properties in connection with methods of forming heat transfer systems having high levels of miscibility in use, including in retrofitting methods such as each of Retrofitting Methods 1-2.

Particular lubricant package compositions of the present invention include those identified in the following Table LPC, wherein the first column of the table includes “LPC” as an abbreviation for a defined Lubricant Package Composition. In Table 1 below: “NR” means that the component or an particular amount is “not required” according to the specified LPC definition and as such its presence in any amount or in no amount is permitted; “Yes” means the component is required but that any type or amount is permitted; “Comp” means that the specified composition comprises the item(s) identified in the table; “CEO” means that the specified composition consists essentially of the item(s) identified in the table; “CO” means that composition consists of the item(s) identified in the table; in column heading “Lubricant,” the specific lubricant, type or specific subcategory of PAG lubricant in the lubricant package composition is identified, with the indicators 1A, 1B, 1C and 1D referring to Base-line miscibility PAG Lubricant definitions corresponding to those designations as defined above, and in this column, PAG means any PAG lubricant, BLVPAG means any base-line viscosity PAG lubricant; in the column headed “PAG, wt %,” indicates that the lubricant package composition comprises the indicated PAG lubricant and when present the amount of the indicated PAG lubricant as a percentage of the lubricant package composition components; the column heading Dispersant indicates the dispersant type or category as defined herein, and in this column the designations “Comp-DM” means the dispersant comprises any one or more of the dispersants identified in Table DM above, “CEO-DM” means the dispersant consists essentially of any one or more of the dispersants identified in Table DM above, and “CO-DM” means the dispersant consists of any one or more of the dispersants identified in Table DM above, SI means succinimide based dispersant, SA means succinamine based dispersant, EA means ethoxylated amine based dispersant; the column heading Dispersant Amount indicates the amount of the indicated dispersant as a weight percentage of the Lubricant Package components; and all amounts are understood to be preceded by the word “about.”

TABLE LPC

| | | | Lubricant | | Dispersant |
|---|---|---|---|---|---|
| LPC | | | Amount, | | Amount, |
| No. | | Lubricant | wt % | Dispersant | wt % |
| 2A | Comp | PAG | NR | Comp-DM | NR |
| 2B | CEO | PAG | NR | Comp-DM | NR |
| 2C | CO | PAG | NR | CO-DM | NR |
| 2D | Comp | PAG | 10-99 | Comp-DM | NR |
| 2E | CEO | PAG | 10-99 | Comp-DM | NR |
| 2F | CO | PAG | 10-99 | CO-DM | NR |
| 2G | Comp | PAG | 10-99 | Comp-DM | 1-90 |
| 2H | CEO | PAG | 10-99 | Comp-DM | 1-90 |
| 2I | CO | PAG | 10-99 | CO-DM | 1-90 |
| 2J | Comp | PAG | 10-90 | Comp-DM | 10-90 |
| 2K | CEO | PAG | 10-90 | Comp-DM | 10-90 |
| 2L | CO | PAG | 10-90 | CO-DM | 10-90 |
| 2M | Comp | PAG | 20-80 | Comp-DM | 20-80 |
| 2N | CEO | PAG | 20-80 | Comp-DM | 20-80 |
| 2O | CO | PAG | 20-80 | CO-DM | 20-80 |
| 3A | Comp | PAG | NR | SI | NR |
| 3B | CEO | PAG | NR | SI | NR |
| 3C | CO | PAG | NR | SI | NR |
| 3D | Comp | PAG | 10-99 | SI | NR |
| 3E | CEO | PAG | 10-99 | SI | NR |
| 3F | CO | PAG | 10-99 | SI | NR |
| 3G | Comp | PAG | 10-99 | SI | 1-90 |
| 3H | CEO | PAG | 10-99 | SI | 1-90 |
| 3I | CO | PAG | 10-99 | SI | 1-90 |
| 3J | Comp | PAG | 10-90 | SI | 10-90 |
| 3K | CEO | PAG | 10-90 | SI | 10-90 |
| 3L | CO | PAG | 10-90 | SI | 10-90 |
| 3M | Comp | PAG | 20-80 | SI | 20-80 |
| 3N | CEO | PAG | 20-80 | SI | 20-80 |
| 3O | CO | PAG | 20-80 | SI | 20-80 |
| 3P | Comp | PAG | NR | SA | NR |
| 3Q | CEO | PAG | NR | SA | NR |
| 3R | CO | PAG | NR | SA | NR |
| 3S | Comp | PAG | 10-99 | SA | NR |
| 3T | CEO | PAG | 10-99 | SA | NR |
| 3U | CO | PAG | 10-99 | SA | NR |
| 3V | Comp | PAG | 10-99 | SA | 1-90 |
| 3X | CEO | PAG | 10-99 | SA | 1-90 |
| 3Y | CO | PAG | 10-99 | SA | 1-90 |
| 3Z | Comp | PAG | 10-90 | SA | 10-90 |
| 3AA | CEO | PAG | 10-90 | SA | 10-90 |
| 3AB | CO | PAG | 10-90 | SA | 10-90 |
| 3AC | Comp | PAG | 20-80 | SA | 20-80 |
| 3AD | CEO | PAG | 20-80 | SA | 20-80 |
| 3AE | CO | PAG | 20-80 | SA | 20-80 |
| 3AF | Comp | PAG | NR | EA | NR |
| 3AG | CEO | PAG | NR | EA | NR |
| 3AH | CO | PAG | NR | EA | NR |
| 3AI | Comp | PAG | 10-99 | EA | NR |
| 3AJ | CEO | PAG | 10-99 | EA | NR |
| 3AK | CO | PAG | 10-99 | EA | NR |
| 3AL | Comp | PAG | 10-99 | EA | 1-90 |
| 3AM | CEO | PAG | 10-99 | EA | 1-90 |
| 3AN | CO | PAG | 10-99 | EA | 1-90 |
| 3AO | Comp | PAG | 10-90 | EA | 10-90 |
| 3AP | CEO | PAG | 10-90 | EA | 10-90 |
| 3AQ | CO | PAG | 10-90 | EA | 10-90 |
| 3AR | Comp | PAG | 20-80 | EA | 20-80 |
| 3AS | CEO | PAG | 20-80 | EA | 20-80 |
| 3AT | CO | PAG | 20-80 | EA | 20-80 |
| 4A | Comp | BLVPAG | 1-99 | PASI | NR |
| 4B | CEO | BLVPAG | 1-99 | PASI | NR |
| 4C | Comp | BLVPAG | 1-99 | PASI | 1-99 |
| 4D | CEO | BLVPAG | 1-99 | PASI | 1-99 |
| 4E | CEO | BLVPAG | 1-99 | PASI | 1 to 90 |
| 4F | Comp | BLVPAG | 1-99 | PASI | 1 to 90 |
| 4G | CEO | BLVPAG | 1-99 | PASI | 1 to 90 |
| 4H | Comp | BLVPAG | 1-99 | PASI | 10 to 90 |
| 4I | CEO | BLVPAG | 1-99 | PASI | 10 to 90 |
| 4J | Comp | BLVPAG | 1-99 | PASI | 10 to 90 |
| 4K | CEO | BLVPAG | 1-99 | PASI | 20 to 80 |
| 4L | CEO | BLVPAG | 1-99 | PASI | 20-80 |
| 5A | Comp | PAG | 1-99 | PASA | NR |
| 5B | CEO | PAG | 1-99 | PASA | NR |
| 5C | Comp | PAG | 1-99 | PASA | 1-99 |
| 5D | CEO | PAG | 1-99 | PASA | 1-99 |
| 5E | Comp | PAG | 1-99 | PASA | 1 to 90 |
| 5F | CEO | BLVPAG | 1-99 | PASA | 1 to 90 |
| 5G | Comp | BLVPAG | 1-99 | PASA | 1 to 90 |
| 5H | CEO | BLVPAG | 1-99 | PASA | 10 to 90 |
| 5I | Comp | BLVPAG | 1-99 | PASA | 10 to 90 |
| 5J | CEO | BLVPAG | 1-99 | PASA | 10 to 90 |
| 5K | Comp | BLVPAG | 1-99 | PASA | 20 to 80 |
| 5L | CEO | BLVPAG | 1-99 | PASA | 20-80 |
| 6A | Comp | PAG | 1-99 | PIBSI | NR |
| 6B | CEO | PAG | 1-99 | PIBSI | NR |
| 6C | Comp | PAG | 1-99 | PIBSI | 1-99 |
| 6D | CEO | PAG | 1-99 | PIBSI | 1-99 |
| 6E | Comp | PAG | 1-99 | PIBSI | 1 to 90 |
| 6F | CEO | BLVPAG | 1-99 | PIBSI | 1 to 90 |
| 6G | Comp | BLVPAG | 1-99 | PIBSI | 1 to 90 |
| 6H | CEO | BLVPAG | 1-99 | PIBSI | 10 to 90 |
| 6I | Comp | BLVPAG | 1-99 | PIBSI | 10 to 90 |
| 6J | CEO | BLVPAG | 1-99 | PIBSI | 10 to 90 |
| 6K | Comp | BLVPAG | 1-99 | PIBSI | 20 to 80 |
| 6L | CEO | BLVPAG | 1-99 | PIBSI | 20 to 80 |
| 7A | Comp | PAG | 1-99 | PIBSA | NR |
| 7B | CEO | PAG | 1-99 | PIBSA | NR |
| 7C | Comp | PAG | 1-99 | PIBSA | 1-99 |
| 7D | CEO | PAG | 1-99 | PIBSA | 1-99 |
| 7E | Comp | PAG | 1-99 | PIBSA | 1 to 90 |
| 7F | CEO | BLVPAG | 1-99 | PIBSA | 1 to 90 |
| 7G | Comp | BLVPAG | 1-99 | PIBSA | 1 to 90 |
| 7H | CEO | BLVPAG | 1-99 | PIBSA | 10 to 90 |
| 7I | Comp | BLVPAG | 1-99 | PIBSA | 10 to 90 |
| 7J | CEO | BLVPAG | 1-99 | PIBSA | 10 to 90 |
| 7K | Comp | BLVPAG | 1-99 | PIBSA | 20 to 80 |
| 7L | CEO | BLVPAG | 1-99 | PIBSA | 20 to 80 |
| 8A | Comp | PAG | 1-99 | PIBSI-PAM | NR |
| 8B | CEO | PAG | 1-99 | PIBSI-PAM | NR |
| 8C | Comp | PAG | 1-99 | PIBSI-PAM | 1-99 |
| 8D | CEO | PAG | 1-99 | PIBSI-PAM | 1-99 |
| 8E | Comp | PAG | 1-99 | PIBSI-PAM | 1 to 90 |
| 8F | CEO | BLVPAG | 1-99 | PIBSI-PAM | 1 to 90 |
| 8G | Comp | BLVPAG | 1-99 | PIBSI-PAM | 1 to 90 |
| 8H | CEO | BLVPAG | 1-99 | PIBSI-PAM | 10 to 90 |
| 8I | Comp | BLVPAG | 1-99 | PIBSI-PAM | 10 to 90 |
| 8J | CEO | BLVPAG | 1-99 | PIBSI-PAM | 10 to 90 |
| 8K | Comp | BLVPAG | 1-99 | PIBSI-PAM | 20 to 80 |
| 8L | CEO | BLVPAG | 1-99 | PIBSI-PAM | 20 to 80 |
| 9A | Comp | PAG | 1-99 | PIBSA-PAM | NR |
| 9B | CEO | PAG | 1-99 | PIBSA-PAM | NR |
| 9C | Comp | PAG | 1-99 | PIBSA-PAM | 1-99 |
| 9D | CEO | PAG | 1-99 | PIBSA-PAM | 1-99 |
| 9E | Comp | PAG | 1-99 | PIBSA-PAM | 1 to 90 |
| 9F | CEO | BLVPAG | 1-99 | PIBSA-PAM | 1 to 90 |
| 9G | Comp | BLVPAG | 1-99 | PIBSA-PAM | 1 to 90 |
| 9H | CEO | BLVPAG | 1-99 | PIBSA-PAM | 10 to 90 |
| 9I | Comp | BLVPAG | 1-99 | PIBSA-PAM | 10 to 90 |
| 9J | CEO | BLVPAG | 1-99 | PIBSA-PAM | 10 to 90 |
| 9K | Comp | BLVPAG | 1-99 | PIBSA-PAM | 20 to 80 |
| 9L | CEO | BLVPAG | 1-99 | PIBSA-PAM | 20 to 80 |
| 10A | Comp | PAG | 1-99 | PIBSI-PAMF1 | NR |
| 10B | CEO | PAG | 1-99 | PIBSI-PAMF1 | NR |
| 10C | Comp | PAG | 1-99 | PIBSI-PAMF1 | 1-99 |
| 10D | CEO | PAG | 1-99 | PIBSI-PAMF1 | 1-99 |
| 10E | Comp | PAG | 1-99 | PIBSI-PAMF1 | 1 to 90 |
| 10F | CEO | BLVPAG | 1-99 | PIBSI-PAMF1 | 1 to 90 |
| 10G | Comp | BLVPAG | 1-99 | PIBSI-PAMF1 | 1 to 90 |
| 10H | CEO | BLVPAG | 1-99 | PIBSI-PAMF1 | 10 to 90 |
| 10I | Comp | BLVPAG | 1-99 | PIBSI-PAMF1 | 10 to 90 |
| 10J | CEO | BLVPAG | 1-99 | PIBSI-PAMF1 | 10 to 90 |
| 10K | Comp | BLVPAG | 1-99 | PIBSI-PAMF1 | 20 to 80 |
| 10L | CEO | BLVPAG | 1-99 | PIBSI-PAMF1 | 20 to 80 |
| 11A | Comp | PAG | 1-99 | PIBSA-PAMF2 | NR |
| 11B | CEO | PAG | 1-99 | PIBSA-PAMF2 | NR |
| 11C | Comp | PAG | 1-99 | PIBSA-PAMF2 | 1-99 |
| 11D | CEO | PAG | 1-99 | PIBSA-PAMF2 | 1-99 |
| 11E | Comp | PAG | 1-99 | PIBSA-PAMF2 | 1 to 90 |
| 11F | CEO | BLVPAG | 1-99 | PIBSA-PAMF2 | 1 to 90 |
| 11G | Comp | BLVPAG | 1-99 | PIBSA-PAMF2 | 1 to 90 |
| 11H | CEO | BLVPAG | 1-99 | PIBSA-PAMF2 | 10 to 90 |
| 11I | Comp | BLVPAG | 1-99 | PIBSA-PAMF2 | 10 to 90 |
| 11J | CEO | BLVPAG | 1-99 | PIBSA-PAMF2 | 10 to 90 |
| 11K | Comp | BLVPAG | 1-99 | PIBSA-PAMF2 | 20 to 80 |
| 11L | CEO | BLVPAG | 1-99 | PIBSA-PAMF2 | 20 to 80 |
| 12A | Comp | PAG | 1-99 | AE | NR |
| 12B | CEO | PAG | 1-99 | AE | NR |
| 12C | Comp | PAG | 1-99 | AE | 1-99 |
| 12D | CEO | PAG | 1-99 | AE | 1-99 |
| 12E | Comp | PAG | 1-99 | AE | 1 to 90 |
| 12F | CEO | BLVPAG | 1-99 | AE | 1 to 90 |
| 12G | Comp | BLVPAG | 1-99 | AE | 1 to 90 |
| 12H | CEO | BLVPAG | 1-99 | AE | 10 to 90 |
| 12I | Comp | BLVPAG | 1-99 | AE | 10 to 90 |
| 12J | CEO | BLVPAG | 1-99 | AE | 10 to 90 |
| 12K | Comp | BLVPAG | 1-99 | AE | 20 to 80 |
| 12L | CEO | BLVPAG | 1-99 | AE | 20 to 80 |
| 13A | Comp | PAG | 1-99 | mAE | NR |
| 13B | CEO | PAG | 1-99 | mAE | NR |
| 13C | Comp | PAG | 1-99 | mAE | 1-99 |
| 13D | CEO | PAG | 1-99 | mAE | 1-99 |
| 13E | Comp | PAG | 1-99 | mAE | 1 to 90 |
| 13F | CEO | BLVPAG | 1-99 | mAE | 1 to 90 |
| 13G | Comp | BLVPAG | 1-99 | mAE | 1 to 90 |
| 13H | CEO | BLVPAG | 1-99 | mAE | 10 to 90 |
| 13I | Comp | BLVPAG | 1-99 | mAE | 10 to 90 |
| 13J | CEO | BLVPAG | 1-99 | mAE | 10 to 90 |
| 13K | Comp | BLVPAG | 1-99 | mAE | 20 to 80 |
| 13L | CEO | BLVPAG | 1-99 | mAE | 20 to 80 |
| 14A | Comp | PAG | 1-99 | pAE | NR |
| 14B | CEO | PAG | 1-99 | pAE | NR |
| 14C | Comp | PAG | 1-99 | pAE | 1-99 |
| 14D | CEO | PAG | 1-99 | pAE | 1-99 |
| 14E | Comp | PAG | 1-99 | pAE | 1 to 90 |
| 14F | CEO | BLVPAG | 1-99 | pAE | 1 to 90 |
| 14G | Comp | BLVPAG | 1-99 | pAE | 1 to 90 |
| 14H | CEO | BLVPAG | 1-99 | pAE | 10 to 90 |
| 14I | Comp | BLVPAG | 1-99 | pAE | 10 to 90 |
| 14J | CEO | BLVPAG | 1-99 | pAE | 10 to 90 |
| 14K | Comp | BLVPAG | 1-99 | pAE | 20 to 80 |
| 14L | CEO | BLVPAG | 1-99 | pAE | 20 to 80 |
| 15A | Comp | PAG | 1-99 | AE-C18 | NR |
| 15B | CEO | PAG | 1-99 | AE-C18 | NR |
| 15C | Comp | PAG | 1-99 | AE-C18 | 1-99 |
| 15D | CEO | PAG | 1-99 | AE-C18 | 1-99 |
| 15E | Comp | PAG | 1-99 | AE-C18 | 1 to 90 |
| 15F | CEO | BLVPAG | 1-99 | AE-C18 | 1 to 90 |
| 15G | Comp | BLVPAG | 1-99 | AE-C18 | 1 to 90 |
| 15H | CEO | BLVPAG | 1-99 | AE-C18 | 10 to 90 |
| 15I | Comp | BLVPAG | 1-99 | AE-C18 | 10 to 90 |
| 15J | CEO | BLVPAG | 1-99 | AE-C18 | 10 to 90 |
| 15K | Comp | BLVPAG | 1-99 | AE-C18 | 20 to 80 |
| 15L | CEO | BLVPAG | 1-99 | AE-C18 | 20 to 80 |
| 16A | Comp | PAG | 1-99 | mAE-C18 | NR |
| 16B | CEO | PAG | 1-99 | mAE-C18 | NR |
| 16C | Comp | PAG | 1-99 | mAE-C18 | 1-99 |
| 16D | CEO | PAG | 1-99 | mAE-C18 | 1-99 |
| 16E | Comp | PAG | 1-99 | mAE-C18 | 1 to 90 |
| 16F | CEO | BLVPAG | 1-99 | mAE-C18 | 1 to 90 |
| 16G | Comp | BLVPAG | 1-99 | mAE-C18 | 1 to 90 |
| 16H | CEO | BLVPAG | 1-99 | mAE-C18 | 10 to 90 |
| 16I | Comp | BLVPAG | 1-99 | mAE-C18 | 10 to 90 |
| 16J | CEO | BLVPAG | 1-99 | mAE-C18 | 10 to 90 |
| 16K | Comp | BLVPAG | 1-99 | mAE-C18 | 20 to 80 |
| 16L | CEO | BLVPAG | 1-99 | mAE-C18 | 20 to 80 |
| 17A | Comp | PAG | 1-99 | pAE-C18 | NR |
| 17B | CEO | PAG | 1-99 | pAE-C18 | NR |
| 17C | Comp | PAG | 1-99 | pAE-C18 | 1-99 |
| 17D | CEO | PAG | 1-99 | pAE-C18 | 1-99 |
| 17E | Comp | PAG | 1-99 | pAE-C18 | 1 to 90 |
| 17F | CEO | BLVPAG | 1-99 | pAE-C18 | 1 to 90 |
| 17G | Comp | BLVPAG | 1-99 | pAE-C18 | 1 to 90 |
| 17H | CEO | BLVPAG | 1-99 | pAE-C18 | 10 to 90 |
| 17I | Comp | BLVPAG | 1-99 | pAE-C18 | 10 to 90 |
| 17J | CEO | BLVPAG | 1-99 | pAE-C18 | 10 to 90 |
| 17K | Comp | BLVPAG | 1-99 | pAE-C18 | 20 to 80 |
| 17L | CEO | BLVPAG | 1-99 | pAE-C18 | 20 to 80 |

### Methods, Uses and Systems

The heat transfer compositions disclosed herein are provided for use in heat transfer applications, including air conditioning applications, with highly preferred air conditioning applications including mobile air conditioning (MAC) systems.

For the MAC systems of the present invention, the system can comprises a loading of refrigerant and lubricant such that the lubricant loading in the system is from about 5% to 60% by weight, or from about 10% to about 60% by weight, or from about 20% to about 50% by weight, or from about 20% to about 40% by weight, or from about 20% to about 30% by weight, or from about 30% to about 50% by weight, or from about 30% to about 40% by weight. As used herein, the term “lubricant loading” refers to the total weight of lubricant contained in the system as a percentage of the total of lubricant and refrigerant contained in the system. Such systems may also include a lubricant loading of from about 5% to about 10% by weight, or about 8% by weight of the heat transfer composition.

The MAC systems according to the present invention can comprise a compressor, an evaporator, a condenser and an expansion device, in fluid communication with each other, a heat transfer composition of the present invention, including each of Heat Transfer Compositions 1-3, and HTCs 4-17, in the system.

The heat transfer compositions of the invention including each of Heat Transfer Compositions 1-3, can be used in heating and cooling applications.

In the heat transfer compositions of the invention, including each of Heat Transfer Compositions 1-3, and HTCs 4-17, the refrigerant is a low Global Warming (GWP) refrigerant, that is, has a GWP of 150 or less.

The present invention thus includes methods of retrofitting existing MAC systems containing R-134a refrigerant, without requiring substantial engineering modification of the existing MAC system, particularly without modification of the condenser, the evaporator and/or the expansion valve.

The present invention thus also includes methods of using a refrigerant or heat transfer composition of the present invention as a replacement for R-134a, and in particular as a replacement for R-134a in MAC systems, without requiring substantial engineering modification of the existing system, particularly without modification of the condenser, the evaporator and/or the expansion valve.

There is therefore provided a method of retrofitting an existing MAC system that contains R-134a refrigerant, said method comprising replacing at least a portion of the existing R-134a refrigerant with a heat transfer composition of the present invention, including each of Heat Transfer Compositions 1-3 and HTCs 4-17.

The present invention also includes a method of retrofitting an existing MAC system that contains R-134a refrigerant and an existing PAG lubricant, said method comprising removing at least a portion of the existing R-134a refrigerant and, after said removing step, introducing into said system a lubricant package of the present invention, including each of Lubricant Packages 1-17.

There present invention also includes a method of retrofitting an existing MAC system that contains R-134a refrigerant and an existing PAG lubricant, said method comprising removing at least a portion of the existing R-134a refrigerant and, after said removing step, introducing into said system a lubricant package of the present invention, including each of Lubricant Packages 1-17, wherein said introducing step comprises combining said lubricant package with a refrigerant and introducing said combined refrigerant and lubricant package into said system.

The step of replacing preferably comprises removing at least a substantial portion of, and preferably substantially all of, the existing R-134a refrigerant and introducing a lubricant package of the present invention, including each of Lubricant Packages 1-17, to produce a heat transfer composition of the present invention, including each of Heat Transfer Compositions 1-3, without any substantial modification of the system to accommodate the refrigerant of the present invention. Preferably, the method comprises removing at least about 5%, at least about 10%, at least about 25%, at least about 50%, or at least about 75% by weight of the R-134a from the system and replacing it with a heat transfer composition of the invention.

Each of the heat transfer compositions described herein, including each of Heat Transfer Compositions 1-3 and HTCs 4-17, is particularly provided to replace R-134a in a MAC system Alternatively, or additionally, each of the heat transfer compositions described herein, including each of Heat Transfer Compositions 1-3 and HTCs 4-17, is particularly provided to replace R-134a in a MAC with a positive displacement compressor, preferably a reciprocating compressor and more preferably a wobble compressor, or rotary (rolling-piston or rotary vane) or scroll compressor.

Each of the heat transfer compositions described herein, including each of Heat Transfer Compositions 1-3, and HTCs 4-17, may further include any one or more of the surfactants as described in copending U.S. Provisional Application 63/692,025, filed Sep. 6, 2024, the entire contents of which are incorporated herein by reference.

### EXAMPLES

### Comparative Examples 1A and 1B—Heat Transfer Compositions Consisting of 1234yf Refrigerant and PAG1 and PAG2 Lubricant

A heat transfer composition consisting of HFO-1234yf and each of PAG1 (Comparative Example 1A) and PAG2 (Comparative Example 1B) lubricants. PAG1 was the PAG lubricant sold under the tradename UCON™ RL897 by DuPont Mobility and Materials, and PAG2 is the PAG lubricant sold under the tradename SP-15 by Dow. The combination of each of PAG1 and PAG2 with 1234yf was tested by placing each of the relative concentrations of the PAG lubricant and HFO-1234yf in a test tube after mixing under a fixed set of temperature conditions varying from −10° C. to 55° C., and then visually evaluating the mixture for evidence of phase formation or separation, as is known to those skilled in the art. If no substantial evidence of phase separation is observed, then the combination at the indicated concentration is determined to be miscible, and otherwise the combination at the indicated concentration is determined to be not miscible. PAG1 was found to be immiscible with HFO-1234yf at each temperature from −10° C. to 55° C. measured in 5° C. increments for each of lubricant weight percent concentrations of 3%, 5%, 10% and 15%. PAG2 was found to be immiscible with HFO-1234yf at each temperature from −10° C. to 55° C. measured in 5° C. increments for each of lubricant weight percent concentrations of 3%, 5%, 10% and 15%. Thus, each of these PAG lubricants is a base-line miscibility PAG lubricant as defined above.

### Examples 1A and 1B—Heat Transfer Compositions Consisting of 1234yf Refrigerant and PAG1 and PAG2 Lubricant and PIBSI-PAM

Comparative Example 1A and 1B are repeated, except that the dispersant PIBSI-PAM-F2 was added to the combination in a series of concentrations ranging from 1% to 5% based on the weight of the lubricant and dispersant. The results of this testing for PAG1 are summarized in Table Ex1A below for the results at −10° C. and 55° C. being shown, with it being understood that when the table indicates that miscibility was achieved at −10° C. and 55° C., this means that miscibility occurs for all results in this range of temperatures.

TABLE Ex1A

| | | Dispersant | | |
|---|---|---|---|---|
| | | PIBSI-PAM-F2 | | |
| | | Wt. % based | | Miscibility |
| Refrigerant | Lubricant | on weight of | | (M = miscible) |
| R1234yf | RL897 | lubricant + | Temperature | (NM = not |
| Parts by weight | | dispersant | ° C. | miscible) |
| 99.99 | 0.01 | 1 | −10 | M |
| | | | 55 | M |
| | | 2.5 | −10 | M |
| | | | 55 | M |
| | | 5 | −10 | M |
| | | | 15 | M |
| 97 | 3 | 1 | −10 | M |
| | | | 55 | M |
| | | 2.5 | −10 | M |
| | | | 55 | M |
| | | 5 | −10 | M |
| | | | 55 | M |
| 95 | 5 | 1 | −10 | M |
| | | | 55 | M |
| | | 2.5 | −10 | M |
| | | | 55 | M |
| | | 5 | −10 | M |
| | | | 55 | M |
| 90 | 10 | 1 | −10 | M |
| | | | 55 | NM |
| | | 2.5 | −10 | M |
| | | | 55 | M |
| | | 5 | −10 | M |
| | | | 55 | M |
| 95 | 15 | 1 | −10 | NM |
| | | | 55 | NM |
| | | 2.5 | −10 | M |
| | | | 55 | M |
| | | 5 | −10 | M |
| | | | 55 | M |

As can be seen from the table above, with 1 weight percent of the dispersant, the combination of 1234yf and PAG1 do not satisfy the requirement of miscibility over all temperatures from −10° C. to 55° C. for lubricant concentration of 10% by weight, and it does not achieve miscibility at any of the temperatures over this temperature range for lubricant concentration of 15% by weight. However, at concentrations above 1% by weight, the requirement of miscibility over all temperatures from −10° C. to 55° C. for lubricant concentration of from 0.01 through 10% by weight is satisfied.

The results of this testing are summarized in Table Ex1B below for the results with PAG2 at −10° C. and −55° C. being shown. It is understood that when the table indicates that miscibility is achieved at −10° C. and 55°, this means that miscibility occurs for all results in this range of temperatures.

TABLE Ex1B

| | | Dispersant | | |
|---|---|---|---|---|
| | | PIBSI-PAM-F2 | | |
| | | Wt. % based | | Miscibility |
| Refrigerant | Lubricant | on weight of | | (M = miscible) |
| R1234yf | SP-15 | lubricant + | Temperature | (NM = not |
| Parts by weight | | dispersant | ° C. | miscible) |
| 99.99 | 0.01 | 1 | −10 | M |
| | | | 55 | M |
| | | 2.5 | −10 | M |
| | | | 55 | M |
| | | 5 | −10 | M |
| | | | 55 | M |
| 97 | 3 | 1 | −10 | M |
| | | | 55 | M |
| | | 2.5 | −10 | M |
| | | | 55 | M |
| | | 5 | −10 | M |
| | | | 55 | M |
| 95 | 5 | 1 | −10 | NM |
| | | | 55 | NM |
| | | 2.5 | −10 | M |
| | | | 55 | M |
| | | 5 | −10 | NM |
| | | | 55 | NM |
| 90 | 10 | 1 | −10 | NM |
| | | | 55 | NM |
| | | 2.5 | −10 | M |
| | | | 55 | NM |
| | | 5 | −10 | M |
| | | | 55 | M |
| 95 | 15 | 1 | −10 | NM |
| | | | 55 | NM |
| | | 2.5 | −10 | M |
| | | | 55 | NM |
| | | 5 | −10 | M |
| | | | 15 | M |

As can be seen from the table above, with 1 weight percent of the dispersant, the combination of 1234yf and PAG2 do not satisfy the requirement of miscibility over any temperatures in the range of from −10° C. to 55° C. for lubricant concentrations of 5%, 10% and 15% by weight. Furthermore, with 2.5 weight percent of the dispersant, the combination of 1234yf and PAG2 do not satisfy the requirement of miscibility over all temperatures in the range of from −10° C. to 55° C. for lubricant concentrations of 5%, 10% and 15% by weight. However, with 5 weight percent of the dispersant, the combination of 1234yf and PAG2 do satisfy the requirement of miscibility over all temperatures in the range of from −10° C. to 55° C. for lubricant concentrations in the entire range of from 0.01% to 15%.

### Comparative Examples 2A and 2B—Heat Transfer Compositions Consisting of 1234yf Refrigerant and PAG3 and PAG4 Lubricant

A heat transfer composition consisting of HFO-1234yf and each of PAG3 (Comparative Example 2A) and PAG4 (Comparative Example 2B) lubricants is formed. PAG3 was the PAG lubricant sold under the tradename ND-8 by Idimitsu, and PAG4 is the PAG lubricant sold under the tradename SP-10 by Idimitsu. The combination of each of PAG3 and PAG4 with 1234yf was tested by placing each of the relative concentrations of the PAG lubricant and HFO-1234yf in a test tube after mixing under a fixed set of temperature conditions varying from −10° C. to 55° C., and then visually evaluating the mixture for evidence of phase formation or separation, as is known to those skilled in the art. If no substantial evidence of phase separation is observed, then the combination at the indicated concentration is determined to be miscible, and otherwise the combination at the indicated concentration is determined to be not miscible. PAG3 was found to be immiscible with HFO-1234yf at each temperature above 50° C. for lubricant concentrations of 5% and above, at each temperature above 40° C. for lubricant concentrations of 10% and above, and at each temperature above 30° C. for lubricant concentrations of about 15%, and above measured in 5° C. increments for each of lubricant weight percent concentrations of 3%, 5%, 10% and 15%. PAG2 was found to be immiscible with HFO-1234yf at each temperature from −10° C. to 55° C. measured in 5° C. increments for each of lubricant weight percent concentrations of 3%, 5%, 10% and 15%. Thus, each of these PAG lubricants is a base-line miscibility PAG lubricant as defined above.

### Examples 2A and 2B—Heat Transfer Compositions Consisting of 1234yf Refrigerant and PAG3 and PAG4 Lubricant and PIBSI-PAM

Comparative Example 2A and 2B are repeated, except that the dispersant PIBSI-PAM-F2 is added to the combination in a series of concentrations ranging from 1% to 5% based on the weight of the lubricant and dispersant. The results of this testing for PAG3 are summarized in Table Ex2A below, with the results at −10° C. and 55° C. being shown. It is understood that when the table indicates that miscibility is achieved at −10° C. and 55° C., this means that miscibility occurs for all results in this range of temperatures.

TABLE Ex2A

| | | Dispersant | | |
|---|---|---|---|---|
| | | PIBSI-PAM-F2 | | |
| | | Wt. % based | | Miscibility |
| Refrigerant | Lubricant | on weight of | | (M = miscible) |
| R1234yf | ND-8 | lubricant + | Temperature | (NM = not |
| Parts by weight | | dispersant | ° C. | miscible) |
| 99.99 | 0.01 | 1 | −10 | M |
| | | | 55 | M |
| | | 2.5 | −10 | M |
| | | | 55 | M |
| | | 5 | −10 | M |
| | | | 15 | M |
| 97 | 3 | 1 | −10 | M |
| | | | 55 | M |
| | | 2.5 | −10 | M |
| | | | 55 | M |
| | | 5 | −10 | M |
| | | | 55 | M |
| 95 | 5 | 1 | −10 | M |
| | | | 55 | M |
| | | 2.5 | −10 | M |
| | | | 55 | M |
| | | 5 | −10 | M |
| | | | 55 | M |
| 90 | 10 | 1 | −10 | M |
| | | | 55 | NM |
| | | 2.5 | −10 | M |
| | | | 55 | M |
| | | 5 | −10 | M |
| | | | 55 | M |
| 95 | 15 | 1 | −10 | NM |
| | | | 55 | NM |
| | | 2.5 | −10 | M |
| | | | 55 | M |
| | | 5 | −10 | M |
| | | | 55 | M |

As can be seen from the table above, with 1 weight percent of the dispersant, the combination of 1234yf and PAG3 do not satisfy the requirement of miscibility over all temperatures from −10° C. to 55° C. for lubricant concentration of 10% by weight, and it does not achieve miscibility at any of the temperatures over this temperature range for lubricant concentration of 15% by weight. However, at concentrations above 1% by weight, the requirement of miscibility over all temperatures from −10° C. to 55° C. for lubricant concentration of from 0.01 through 10% by weight is satisfied.

The results of this testing are summarized in Table Ex2B below with the results with PAG4 at −10° C. and −55° C. being shown. It being understood that when the table indicates that miscibility is achieved at −10° C. and 55° C. this reflects that miscibility occurs for all results in this range of temperatures.

TABLE Ex2B

| | | Dispersant | | |
|---|---|---|---|---|
| | | PIBSI-PAM-F2 | | |
| | | Wt. % based | | Miscibility |
| Refrigerant | Lubricant | on weight of | | (M = miscible) |
| R1234yf | SP-10 | lubricant + | Temperature | (NM = not |
| Parts by weight | | dispersant | ° C. | miscible) |
| 99.99 | 0.01 | 1 | −10 | M |
| | | | 55 | M |
| | | 2.5 | −10 | M |
| | | | 55 | M |
| | | 5 | −10 | M |
| | | | 55 | M |
| 97 | 3 | 1 | −10 | M |
| | | | 55 | M |
| | | 2.5 | −10 | M |
| | | | 55 | M |
| | | 5 | −10 | M |
| | | | 55 | M |
| 95 | 5 | 1 | −10 | NM |
| | | | 55 | NM |
| | | 2.5 | −10 | M |
| | | | 55 | M |
| | | 5 | −10 | NM |
| | | | 55 | NM |
| 90 | 10 | 1 | −10 | NM |
| | | | 55 | NM |
| | | 2.5 | −10 | M |
| | | | 55 | NM |
| | | 5 | −10 | M |
| | | | 55 | M |
| 95 | 15 | 1 | −10 | NM |
| | | | 55 | NM |
| | | 2.5 | −10 | M |
| | | | 55 | NM |
| | | 5 | −10 | M |
| | | | 15 | M |

As can be seen from the table above, with 1 weight percent of the dispersant, the combination of 1234yf and PAG4 does not satisfy the requirement of miscibility over any temperatures in the range of from −10° C. to 55° C. for lubricant concentrations of 5%, 10% and 15% by weight. Furthermore, with 2.5 weight percent of the dispersant, the combination of 1234yf and PAG4 do not satisfy the requirement of miscibility over all temperatures in the range of from −10° C. to 55° C. for lubricant concentrations of 5%, 10% and 15% by weight. However, with 5 weight percent of the dispersant, the combination of 1234yf and PAG4 do satisfy the requirement of miscibility over all temperatures in the range of from −10° C. to 55° C. for lubricant concentrations in the entire range of from 0.01% to 15%.

### Examples 3A and 3B—Heat Transfer Compositions Consisting of 1234yt Refrigerant and PAG1 and PAG2 Lubricant and EA

Comparative Example 1A and 1B are repeated, except that an ethoxylated amine with an alkyl chain length of about 18 (“EAC18”) dispersant was added to the combination in a series of concentrations ranging from 1% to 5% based on the weight of the lubricant and dispersant. The results of this testing for PAG1 are summarized in Table Ex3A below, with the results at −10° C. and 55° C. being shown. It is understood that when the table indicates that miscibility is achieved at −10° C. and 55° C., this means that miscibility occurs for all results in this range of temperatures.

TABLE Ex3A

| | | Dispersant | | |
|---|---|---|---|---|
| | | EAC18 | | |
| | | Wt. % based | | Miscibility |
| Refrigerant | Lubricant | on weight of | | (M = miscible) |
| R1234yf | RL897 | lubricant + | Temperature | (NM = not |
| Parts by weight | | dispersant | ° C. | miscible) |
| 99.99 | 0.01 | 1 | −10 | M |
| | | | 55 | M |
| | | 2.5 | −10 | M |
| | | | 55 | M |
| | | 5 | −10 | M |
| | | | 15 | M |
| 97 | 3 | 1 | −10 | M |
| | | | 55 | M |
| | | 2.5 | −10 | M |
| | | | 55 | M |
| | | 5 | −10 | M |
| | | | 55 | M |
| 95 | 5 | 1 | −10 | M |
| | | | 55 | M |
| | | 2.5 | −10 | M |
| | | | 55 | M |
| | | 5 | −10 | M |
| | | | 55 | M |
| 90 | 10 | 1 | −10 | M |
| | | | 55 | NM |
| | | 2.5 | −10 | M |
| | | | 55 | M |
| | | 5 | −10 | M |
| | | | 55 | M |
| 95 | 15 | 1 | −10 | NM |
| | | | 55 | NM |
| | | 2.5 | −10 | M |
| | | | 55 | M |
| | | 5 | −10 | M |
| | | | 55 | M |

As can be seen from the table above, with 1 weight percent of the dispersant, the combination of 1234yf and PAG1 do not satisfy the requirement of miscibility over all temperatures from −10° C. to 55° C. for lubricant concentration of 10% by weight, and it does not achieve miscibility at any of the temperatures over this temperature range for lubricant concentration of 15% by weight. However, at concentrations above 1% by weight, the requirement of miscibility over all temperatures from −10° C. to 55° C. for lubricant concentration of from 0.01 through 10% by weight is satisfied.

The results of this testing are summarized in Table Ex3B below for the results with PAG2 at −10° C. and 55° C. being shown. It is understood that when the table indicates that miscibility is achieved at −10° C. and 55° C., this means that miscibility occurs for all results in this range of temperatures.

TABLE Ex3B

| | | Dispersant | | |
|---|---|---|---|---|
| | | EAC18 | | |
| | | Wt. % based | | Miscibility |
| Refrigerant | Lubricant | on weight of | | (M = miscible) |
| R1234yf | SP-15 | lubricant + | Temperature | (NM = not |
| Parts by weight | | dispersant | ° C. | miscible) |
| 99.99 | 0.01 | 1 | −10 | M |
| | | | 55 | M |
| | | 2.5 | −10 | M |
| | | | 55 | M |
| | | 5 | −10 | M |
| | | | 55 | M |
| 97 | 3 | 1 | −10 | M |
| | | | 55 | M |
| | | 2.5 | −10 | M |
| | | | 55 | M |
| | | 5 | −10 | M |
| | | | 55 | M |
| 95 | 5 | 1 | −10 | NM |
| | | | 55 | NM |
| | | 2.5 | −10 | M |
| | | | 55 | M |
| | | 5 | −10 | NM |
| | | | 55 | NM |
| 90 | 10 | 1 | −10 | NM |
| | | | 55 | NM |
| | | 2.5 | −10 | M |
| | | | 55 | NM |
| | | 5 | −10 | M |
| | | | 55 | M |
| 95 | 15 | 1 | −10 | NM |
| | | | 55 | NM |
| | | 2.5 | −10 | M |
| | | | 55 | NM |
| | | 5 | −10 | M |
| | | | 15 | M |

As can be seen from the table above, with 1 weight percent of the dispersant, the combination of 1234yf and PAG2 do not satisfy the requirement of miscibility over any temperatures in the range of from −10° C. to 55° C. for lubricant concentrations of 5%, 10% and 15% by weight. Furthermore, with 2.5 weight percent of the dispersant, the combination of 1234yf and PAG2 do not satisfy the requirement of miscibility over all temperatures in the range of from −10° C. to 55° C. for lubricant concentrations of 5%, 10% and 15% by weight. However, with 5 weight percent of the dispersant, the combination of 1234yf and PAG2 do satisfy the requirement of miscibility over all temperatures in the range of from −10° C. to 55° C. for lubricant concentrations in the entire range of from 0.01% to 15%.

### Examples 4A and 4B—Heat Transfer Compositions Consisting of 1234yt Refrigerant and PAG3 and PAG4 Lubricant and EA

Comparative Example 2A and 2B are repeated, except that the same EA dispersant as used in Examples 3A and 3B is added to the combination in a series of concentrations ranging from 1% to 5% based on the weight of the lubricant and dispersant. The results of this testing for PAG3 are summarized in Table Ex4A below, with the results at −10° C. and 55° C. being shown. It is understood that when the table indicates that miscibility is achieved at −10° C. and 55° C., this means that miscibility occurs for all results in this range of temperatures.

TABLE 4A

| | | Dispersant | | |
|---|---|---|---|---|
| | | EAC18 | | |
| | | Wt. % based | | Miscibility |
| Refrigerant | Lubricant | on weight of | | (M = miscible) |
| R1234yf | ND-8 | lubricant + | Temperature | (NM = not |
| Parts by weight | | dispersant | ° C. | miscible) |
| 99.99 | 0.01 | 1 | −10 | M |
| | | | 55 | M |
| | | 2.5 | −10 | M |
| | | | 55 | M |
| | | 5 | −10 | M |
| | | | 15 | M |
| 97 | 3 | 1 | −10 | M |
| | | | 55 | M |
| | | 2.5 | −10 | M |
| | | | 55 | M |
| | | 5 | −10 | M |
| | | | 55 | M |
| 95 | 5 | 1 | −10 | M |
| | | | 55 | M |
| | | 2.5 | −10 | M |
| | | | 55 | M |
| | | 5 | −10 | M |
| | | | 55 | M |
| 90 | 10 | 1 | −10 | M |
| | | | 55 | NM |
| | | 2.5 | −10 | M |
| | | | 55 | M |
| | | 5 | −10 | M |
| | | | 55 | M |
| 95 | 15 | 1 | −10 | NM |
| | | | 55 | NM |
| | | 2.5 | −10 | M |
| | | | 55 | M |
| | | 5 | −10 | M |
| | | | 55 | M |

As can be seen from the table above, with 1 weight percent of the dispersant, the combination of 1234yf and PAG3 do not satisfy the requirement of miscibility over all temperatures from −10° C. to 55° C. for lubricant concentration of 10% by weight, and it does not achieve miscibility at any of the temperatures over this temperature range for lubricant concentration of 15% by weight. However, at concentrations above 1% by weight, the requirement of miscibility over all temperatures from −10° C. to 55° C. for lubricant concentration of from 0.01 through 10% by weight is satisfied.

The results of this testing are summarized in Table Ex4B below with the results with PAG4 at −10° C. and −55° C. being shown. It is understood that when the table indicates that miscibility is achieved at −10° C. and 55° C. this reflects that miscibility occurs for all results in this range of temperatures.

TABLE Ex4B

| | | Dispersant | | |
|---|---|---|---|---|
| | | EAC18 | | |
| | | Wt. % based | | Miscibility |
| Refrigerant | Lubricant | on weight of | | (M = miscible) |
| R1234yf | SP-10 | lubricant + | Temperature | (NM = not |
| Parts by weight | | dispersant | ° C. | miscible) |
| 99.99 | 0.01 | 1 | −10 | M |
| | | | 55 | M |
| | | 2.5 | −10 | M |
| | | | 55 | M |
| | | 5 | −10 | M |
| | | | 55 | M |
| 97 | 3 | 1 | −10 | M |
| | | | 55 | M |
| | | 2.5 | −10 | M |
| | | | 55 | M |
| | | 5 | −10 | M |
| | | | 55 | M |
| 95 | 5 | 1 | −10 | NM |
| | | | 55 | NM |
| | | 2.5 | −10 | M |
| | | | 55 | M |
| | | 5 | −10 | NM |
| | | | 55 | NM |
| 90 | 10 | 1 | −10 | NM |
| | | | 55 | NM |
| | | 2.5 | −10 | M |
| | | | 55 | NM |
| | | 5 | −10 | M |
| | | | 55 | M |
| 95 | 15 | 1 | −10 | NM |
| | | | 55 | NM |
| | | 2.5 | −10 | M |
| | | | 55 | NM |
| | | 5 | −10 | M |
| | | | 15 | M |

As can be seen from the table above, with 1 weight percent of the dispersant, the combination of 1234yf and PAG4 does not satisfy the requirement of miscibility over any temperatures in the range of from −10° C. to 55° C. for lubricant concentrations of 5%, 10% and 15% by weight. Furthermore, with 2.5 weight percent of the dispersant, the combination of 1234yf and PAG4 do not satisfy the requirement of miscibility over all temperatures in the range of from −10° C. to 55° C. for lubricant concentrations of 5%, 10% and 15% by weight. However, with 5 weight percent of the dispersant, the combination of 1234yf and PAG4 do satisfy the requirement of miscibility over all temperatures in the range of from −10° C. to 55° C. for lubricant concentrations in the entire range of from 0.01% to 15%.

### Example 5—Retrofit of R-134a Automobile Air Conditioning System Containing PAG1 Using PIBSI-PAM Dispersant

This example illustrates a method of retrofitting a MAC system, particularly an automobile air conditioning system, utilizing PAG1 lubricant of the Comparative Example 1A as the compressor lubricant and R134a as the refrigerant. The method is carried out by removing a large proportion, and preferably at least about 75% by weight and even more preferably at least about 90% by weight, of the HFC-134a from the system, but without taking steps to remove the PAG1 lubricant from the system. For this example, approximately 100% of the PAG1 lubricant in the system remains in the system after said refrigerant removing step, and this amount of PAG1 lubricant is about equal to the design lubricant load for the system. A supplemental lubricant package comprising a supplemental PAG lubricant in an amount of about 20% by weight of the design lubricant load and from greater than 1% by weight to about 5% by weight of PIBSI-PAM (based on the weight of the supplemental PAG lubricant and PIBSI-PAM) is added to the system. The system is operated with a condenser temperature of about 55° C. and an evaporator temperature of about −10° C. and with oil circulation rates of from about 0.01 wt % to about 10 wt %. As used herein, oil circulation rate refers to the concentration of lubricant that is in the compressor discharge stream based on the weight of refrigerant and lubricant. For all such circulation rates the combination of 1234yf refrigerant and PAG1 exist in the system as a single phase fluid.

### Example 6—Retrofit of R-134a Automobile Air Conditioning System Containing PAG2 Using PIBSI-PAM Dispersant

Example 5 is repeated, except PAG2 lubricant is the existing refrigerant and the supplemental lubricant package comprises from greater than 2.5% by weight to about 5% by weight of PIBSI-PAM (based on the weight of the PAG lubricant and PIBSI-PAM). As with Example 5, the system is operated with oil circulation rates of from about 0.01 wt % to about 10 wt %, and for all such circulation rates the combination of 1234yf refrigerant and PAG2 exist in the system as a single phase fluid.

### Example 7—Retrofit of R-134a Automobile Air Conditioning System Containing PAG3 Using PIBSI-PAM Dispersant

Example 5 is repeated, except PAG3 lubricant is the existing refrigerant instead of PAG1. As with Example 5, the system is operated with oil circulation rates of from about 0.01 wt % to about 10 wt %, and for all such circulation rates the combination of 1234yf refrigerant and PAG3 exist in the system as a single phase fluid.

### Example 8—Retrofit of R-134a Automobile Air Conditioning System Containing PAG4 Using PIBSI-PAM Dispersant

Example 5 is repeated, except PAG4 lubricant is the existing refrigerant instead of PAG1. As with Example 5, the system is operated with oil circulation rates of from about 0.01 wt % to about 10 wt %, and for all such circulation rates the combination of 1234yf refrigerant and PAG4 exist in the system as a single phase fluid.

### Example 9—Retrofit of R-134a Automobile Air Conditioning System Containing PAG1 Using EA Dispersant

This example illustrates a method of retrofitting a MAC system, particularly an automobile air conditioning system, utilizing PAG1 lubricant of the Comparative Example 1A as the compressor lubricant and R134a as the refrigerant. The method is carried out by removing a large proportion, and preferably at least about 75% by weight and even more preferably at least about 90% by weight, of the HFC-134a from the system, but without taking steps to remove the PAG1 lubricant from the system. For this example, approximately 100% of the PAG1 lubricant in the system remains in the system after said refrigerant removing step, and this amount of PAG1 lubricant is about equal to the design lubricant load for the system. A supplemental lubricant package comprising a supplemental PAG lubricant in an amount of about 20% by weight of the design lubricant load and from greater than 1% by weight to about 5% by weight of EAC18 dispersant (based on the weight of the supplemental PAG lubricant and EA) is added to the system. The system is operated with a condenser temperature of about 55° C. and an evaporator temperature of about −10° C. and with oil circulation rates of from about 0.01 wt % to about 10 wt %, and for all such circulation rates the combination of 1234yf refrigerant and PAG1 exist in the system as a single phase fluid.

### Example 10—Retrofit of R-134a Automobile Air Conditioning System Containing PAG2 Using EA Dispersant

Example 9 is repeated, except PAG2 lubricant is the existing refrigerant and the supplemental lubricant package comprises from greater than 2.5% by weight to about 5% by weight of EAC18 (based on the weight of the PAG lubricant and EA). As with Example 9, the system is operated with oil circulation rates of from about 0.01 wt % to about 10 wt %, and for all such circulation rates the combination of 1234yf refrigerant and PAG2 exist in the system as a single phase fluid.

### Example 11—Retrofit of R-134a Automobile Air Conditioning System Containing PAG3 Using PIBSA-PAM Dispersant

Example 9 is repeated, except PAG3 lubricant is the existing refrigerant instead of PAG1. As with Example 9, the system is operated with oil circulation rates of from about 0.01 wt % to about 10 wt %, and for all such circulation rates the combination of 1234yf refrigerant and PAG3 exist in the system as a single phase fluid.

### Example 12—Retrofit of R-134a Automobile Air Conditioning System Containing PAG4 Using PIBSA-PAM Dispersant

Example 9 is repeated, except PAG4 lubricant is the existing refrigerant instead of PAG1. As with Example 9, the system is operated with oil circulation rates of from about 0.01 wt % to about 10 wt %, and for all such circulation rates the combination of 1234yf refrigerant and PAG4 exist in the system as a single-phase fluid.

1. A liquid heat transfer composition comprising refrigerant, lubricant and dispersant, wherein:
(a) said refrigerant comprises at least about 50% by weight of HFO-1234yf;
(b) said lubricant consists essentially of PAG lubricant in an amount of from about 0.01% by weight to about 10% by weight based on the weight of said refrigerant and said lubricant; and
(c) said dispersant is present in an amount of from greater than about 1% by weight to about 5% by weight based on the weight of said PAG lubricant and said dispersant; and
(d) said heat transfer composition is a single-phase fluid over the temperature range of from about −10° C. to about 55° C.

2. The liquid heat transfer composition of claim 1 wherein said heat transfer composition is not a single-phase fluid over the temperature range of from about −10° C. to about 55° C. in the absence of said dispersant.

3. The liquid heat transfer composition of claim 1 wherein said PAG lubricant is a base-line miscibility PAG lubricant.

4. The liquid heat transfer composition of claim 3 wherein said dispersant is present in an amount of from about 2.5% by weight to about 5% by weight based on the weight of said base-line miscibility PAG lubricant and said dispersant.

5. The liquid heat transfer composition of claim 1 wherein said dispersant comprises one or more polyalkylsuccinamide-polyamines and/or one or more amine ethoxylates.

6. A method of retrofitting an existing MAC system containing R-134a and existing PAG lubricant with a refrigerant comprising HFO-1234yf, said retrofitting methods comprising: (a) ensuring that the existing MAC system is essentially free of the existing R134a refrigerant without taking steps to remove any existing PAG lubricant that remains in the system after said R134a removal; (b) after said ensuring step (a), introducing into the system refrigerant comprising at least about 50% by weight of HFO-1234yf and (c) either before, after, and/or simultaneous with said introducing step (b), introducing into the system a supplemental PAG lubricant composition, wherein the amount of said supplemental PAG lubricant introduced is from about 5% to about 20% of the design lubricant load of the system, wherein the supplemental PAG lubricant composition comprises a dispersing agent which enhances the miscibility of said existing PAG lubricant and said HFO-1234yf.

7. The retrofitting method of claim 6 wherein after said introducing step (c), said refrigerant, said lubricant and said dispersant are a single-phase fluid over the temperature range of from about −10° C. to about 55° C.

8. The retrofitting method of claim 6 wherein in the absence of said dispersant, said refrigerant and said lubricant are not a single-phase fluid over the temperature range of from about −10° C. to about 55° C.

9. The retrofitting method of claim 6 wherein said existing PAG lubricant comprises a base-line miscibility PAG lubricant.

10. The retrofitting method of claim 6 wherein said dispersant comprises one or more polyalkylsuccinamide-polyamines and/or one or more amine ethoxylates.

11. A method of retrofitting an existing MAC system that contains R-134a refrigerant and an existing PAG lubricant, said method comprising:
a. removing at least a portion of the existing R-134a refrigerant from said existing system; and
b. after said removing step, introducing into said existing system a lubricant package composition comprising supplemental PAG lubricant and a dispersing agent, wherein said dispersing agent comprises one or more polyalkylsuccinamide-polyamine based agents and/or one or more polyalkylsuccinimide-polyamine based dispersing agents and/or one or more ethoxylated amine dispersing agents, wherein said dispersing agent is present in the lubricant package in an amount of from about 20% by weight to about 80% by weight based on the weight of said supplemental PAG lubricant and said dispersant.

12. The retrofitting method of claim 11 wherein said introducing step comprises:
a. combining said lubricant package with R1234yf refrigerant; and
b. introducing said combined lubricant package and said R1234yf into said system.

13. The retrofitting method of claim 11 further comprising, after said removing step and either before or after said introducing step b:
c. introducing into said system R1234yf refrigerant.

14. The retrofitting method of claim 11 wherein said dispersing agent is selected from the group consisting of PASI, PASA, PIBSI, PIBSA, PIBSI-PAM, PIBSA-PAM, PIBSA-PAM-F1, PIBSA-PAM-F2, AE, mAE, pAE, AE-C18, mAE-C18, pAE-C18 and combinations of two or more of these.

15. The retrofitting method of claim 13 wherein after said introducing step b. and said introducing step c., any of said existing PAG refrigerant that is present, said R1234yf refrigerant, said lubricant and said dispersant are a single-phase fluid over the temperature range of from about −10° C. to about 55° C.

16. The retrofitting method of claim 15, wherein in the absence of said dispersant, said existing PAG refrigerant that is present, said R1234yf refrigerant and said lubricant are not a single-phase fluid over the temperature range of from about-10° C. to about 55° C.

17. The retrofitting method of claim 16 wherein said existing PAG lubricant comprises a base-line miscibility PAG lubricant.

18. The retrofitting method of claim 12 wherein after said introducing step, any of said existing PAG refrigerant that is present, said R1234yf refrigerant, said lubricant and said dispersant are a single-phase fluid over the temperature range of from about −10° C. to about 55° C.

19. The retrofitting method of claim 18, wherein in the absence of said dispersant, said existing PAG refrigerant that is present, said R1234yf refrigerant and said lubricant are not a single-phase fluid over the temperature range of from about −10° C. to about 55° C.

20. The retrofitting method of claim 19 wherein said existing PAG lubricant comprises a base-line miscibility PAG lubricant.
